(19) United States
(12) Patent Application Publication
(10) Pub. No.: US 2015/0152003 A1
(43) Pub. Date: Jun. 4, 2015

(54) REINFORCED GLASS, REINFORCED GLASS PLATE, AND GLASS TO BE REINFORCED

(71) Applicant: Nippon Electric Glass Co., Ltd., Shiga (JP)

(72) Inventors: Kosuke Kawamoto, Shiga (JP); Takashi Murata, Shiga (JP)

(21) Appl. No.: 14/406,922

(22) PCT Filed: Jun. 13, 2013
(86) PCT No.: PCT/JP2013/066309

§ 371 Date: Dec. 10, 2014

(30) Foreign Application Priority Data
Jun. 13, 2012 (JP) 2012-133451
Aug. 3, 2012 (JP) 2012-172541
Sep. 14, 2012 (JP) 2012-202409
Dec. 13, 2012 (JP) 2012-272120
Feb. 1, 2013 (JP) 2013-018362

(51) Int. Cl. C03C 3/083; C03C 4/18

(52) U.S. Cl. CPC C03C 3/083; C03C 4/18

(57) ABSTRACT

A tempered glass is a tempered glass having a compression stress layer in a surface thereof, comprising as a glass composition, in terms of mol %, 50 to 80% of SiO₂, 5 to 30% of Al₂O₃, 0 to 2% of Li₂O, and 5 to 25% of Na₂O, and being substantially free of As₂O₃, Sb₂O₃, PbO, and F.

### TECHNICAL FIELD

The present invention relates to a tempered glass, a tempered glass sheet, and a glass to be tempered, and more particularly, to a tempered glass, a tempered glass sheet, and a glass to be tempered suitable for a cover glass for a cellular phone, a digital camera, a personal digital assistant (PDA), or a solar battery, or a glass substrate for a display, in particular, a touch panel display.

### BACKGROUND ART

Devices such as a cellular phone, a digital camera, a PDA, a touch panel display, a large-screen television, and contact-less power transfer show a tendency of further prevalence.

A tempered glass, which is produced by applying tempering treatment to glass through ion exchange treatment or the like, is used for those applications (see Patent Literature 1 and Non Patent Literature 1).

In addition, in recent years, the tempered glass has been more and more frequently used in exterior parts of, for example, digital signage, mice, and smartphones.

Main characteristics required of the tempered glass include (1) high mechanical strength, (2) high flaw resistance, (3) lightweight, and (4) low cost. In its use in smartphones, there is an increasing demand for a reduction in weight, that is, a reduction in sheet thickness. Meanwhile, when the related-art tempered glass is reduced in thickness to achieve the reduction in weight, its internal tensile stress becomes excessively high. Accordingly, the reduction in thickness involves a risk that broken pieces of the tempered glass may be scattered at the time of its breakage or the tempered glass may undergo spontaneous breakage. Thus, there is a limitation on enhancing mechanical strength of the tempered glass by increasing a compression stress value or thickness of its compression stress layer.

In view of the foregoing, it is effective to suppress creation of a surface flaw on the tempered glass to the extent possible, thereby suppressing lowering of its mechanical strength.

### CITATION LIST

### Patent Literature

[PTL 1] JP 2006-83045 A

### Non Patent Literature

[NPL 1] Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

Hitherto, an Li₂O-rich glass has been proposed as a glass to be tempered on which a flaw is hardly created, that is, a glass to be tempered having high crack resistance. However, it is difficult to obtain a high liquidus viscosity in the Li₂O-rich glass. In addition, when the Li₂O-rich glass is subjected to ion exchange treatment using a KNO₃ molten salt, Li ions are liable to be mixed in the KNO₃ molten salt. When such KNO₃ molten salt is used, a problem arises in that the tempering characteristic of the glass to be tempered becomes insufficient.

Further, as the content of Li₂O increases, the thermal expansion coefficient of the glass to be tempered is liable to become higher. In addition, the ion exchange treatment is generally performed by immersing the glass to be tempered in a high-temperature (for example, from 300 to 500° C.) KNO₃ molten salt. Thus, the ion exchange treatment of the Li₂O-rich glass involves a problem in that the glass is liable to undergo breakage owing to a thermal shock when the glass to be tempered is immersed or when the tempered glass sheet is taken out.

In order to solve the problem, it is conceivable to employ a method involving preheating a glass sheet to be tempered before immersion, or annealing a tempered glass sheet that has been taken out. However, such method requires a long period of time, and hence involves a risk that the manufacturing cost of the tempered glass sheet may soar.

The present invention has been made in view of the above-mentioned circumstances, and a technical object of the present invention is to provide a tempered glass, tempered glass sheet, and glass to be tempered that have satisfactory ion exchange performance, denitrification resistance, and thermal shock resistance, hardly undergo lowering of the tempering characteristic of the glass to be tempered in a KNO₃ molten salt, and have high crack resistance.

### Solution to Problem

The inventors of the present invention have made various studies and have consequently found that the technical object can be achieved by strictly controlling the glass composition. Thus, the finding is proposed as the present invention. That is, a tempered glass of the present invention has a compression stress layer in a surface thereof, comprises as a glass composition, in terms of mol %, 50 to 80% of SiO₂, 5 to 30% of Al₂O₃, 0 to 2% of Li₂O, and 5 to 25% of Na₂O, and is substantially free of As₂O₃, Sb₂O₃, PbO, and F. Herein, the gist of the phrase “substantially free of As₂O₃” resides in that As₂O₃ is not added positively as a glass component, but contamination with As₂O₃ as an impurity is allowable. Specifically, the phrase means that the content of As₂O₃ is less than 0.1 mol %. The gist of the phrase “substantially free of Sb₂O₃” resides in that Sb₂O₃ is not added positively as a glass component, but contamination with Sb₂O₃ as an impurity is allowable. Specifically, the phrase means that the content of Sb₂O₃ is less than 0.1 mol %. The gist of the phrase “substantially free of PbO” resides in that PbO is not added positively as a glass component, but contamination with PbO as an impurity is allowable. Specifically, the phrase means that the content of PbO is less than 0.1 mol %. The gist of the phrase “substantially free of F” resides in that F is not added positively as a glass component, but contamination with F as an impurity is allowable. Specifically, the phrase means that the content of F is less than 0.1 mol %.

The introduction of given amounts of Al₂O₃ and the alkali metal oxides (in particular, Na₂O) into the glass composition can enhance ion exchange performance, denitrification resistance, and thermal shock resistance. It should be noted that the introduction of a given amount of B₂O₃ can enhance crack resistance.

Second, the tempered glass of the present invention preferably comprises as a glass composition, in terms of mol %, 50 to 80% of SiO₂, 6.5 to 15% of Al₂O₃, 0 to 1.7% of Li₂O, more than 7.0 to 15.5% of Na₂O, 0 to 2% of CaO, and 0 to 1% of P₂O₅, and is preferably substantially free of As₂O₃, Sb₂O₃, PbO, and F.

Third, the tempered glass of the present invention preferably comprises as a glass composition, in terms of mol %, 50 to 80% of SiO₂, 6.5 to 15% of Al₂O₃, 0 to 1% of Li₂O, 9 to 15.5% of Na₂O, 0 to 2% of CaO, 0 to 6.5% of MgO+CaO+SrO+BaO, and 0 to 0.1% of P₂O₅, and is preferably substantially free of As₂O₃, Sb₂O₃, PbO, and F. Herein, the term “MgO+CaO+SrO+BaO” means the total amount of MgO, CaO, SrO, and BaO.

Fourth, the tempered glass of the present invention preferably comprises as a glass composition, in terms of mol %, 50 to 80% of SiO₂, 6.5 to 15% of Al₂O₃, 0.01 to 15% of B₂O₃, 0 to 1% of Li₂O, 9 to 15.5% of Na₂O, 9 to 15.5% of Li₂O+Na₂O+K₂O, 0 to 2% of CaO, 0 to 6.5% of MgO+CaO+SrO+BaO, and 0 to 0.1% of P₂O₅, and is preferably substantially free of As₂O₃, Sb₂O₃, PbO, and F. Herein, the term “Li₂O+Na₂O+K₂O” means the total amount of Li₂O, Na₂O, and K₂O.

Fifth, the tempered glass of the present invention preferably comprises as a glass composition, in terms of mol %, 50 to 77% of SiO₂, 6.5 to 15% of Al₂O₃, 0.01 to 15% of B₂O₃, 0 to 1% of Li₂O, 9 to 15.5% of Na₂O, 9 to 15.5% of Li₂O+Na₂O+K₂O, 0 to 2% of CaO, 0 to 6.5% of MgO+CaO+SrO+BaO, 15.5 to 22% of Li₂O+Na₂O+K₂O+MgO+CaO+SrO+BaO, and 0 to 0.1% of P₂O₅, and is preferably substantially free of As₂O₃, Sb₂O₃, PbO, and F. Herein, the term “Li₂O+Na₂O+K₂O+MgO+CaO+SrO+BaO” means the total amount of Li₂O, Na₂O, K₂O, MgO, CaO, SrO, and BaO.

Sixth, the tempered glass of the present invention preferably comprises as a glass composition, in terms of mol %, 50 to 77% of SiO₂, 6.5 to 15% of Al₂O₃, 0.01 to 10% of B₂O₃, 0 to 1% of Li₂O, 9 to 15.5% of Na₂O, 9 to 15.5% of Li₂O+Na₂O+K₂O, 0 to 2% of CaO, 0 to 6.5% of MgO+CaO+SrO+BaO, 15.5 to 22% of Li₂O+Na₂O+K₂O+MgO+CaO+SrO+BaO, and 0 to 0.1% of P₂O₅, preferably has a molar ratio B₂O₃/(B₂O₃+Li₂O+Na₂O+K₂O+MgO+CaO+SrO+BaO) of from 0.06 to 0.35, and is preferably substantially free of As₂O₃, Sb₂O₃, PbO, and F.

Seventh, the tempered glass of the present invention preferably has a density of 2.45 g/cm or less. Herein, the “density” can be measured by a known Archimedes method.

Eighth, the tempered glass of the present invention preferably has a crack resistance before tempering treatment of 300 gf or more. Herein, the “crack resistance” refers to a load at a crack generation rate of 50%. In addition, the “crack generation rate” refers to a value measured as described below. First, in a constant temperature and humidity chamber kept at a humidity of 30% and a temperature of 25° C., a Vickers indenter set to a predetermined load is driven into a glass surface (optically polished surface) for 15 seconds, and 15 seconds after that, the number of cracks generated from the four corners of the indentation is counted (4 per indentation at maximum). The indenter is driven in this manner 20 times, the total number of generated cracks is determined, and then the crack generation rate is determined by the following expression: total number of generated cracks/80×100(%).

Ninth, in the tempered glass of the present invention, it is preferred that a compression stress value of the compression stress layer be 300 MPa or more, and a thickness of the compression stress layer be 10 μm or more.

Tenth, the tempered glass of the present invention preferably has a liquidus temperature of 1,200° C. or less. Herein, the phrase “liquidus temperature” refers to a temperature at which crystals of glass are deposited after glass powder that passes through a standard 30-mesh sieve (sieve opening: 500 μm) and remains on a 50-mesh sieve (sieve opening: 300 μm) is placed in a platinum boat and then kept for 24 hours in a gradient heating furnace.

Eleventh, the tempered glass of the present invention preferably has a liquidus viscosity of 10^{4.0} dPa·s or more. Herein, the phrase “liquidus viscosity” refers to a value obtained through measurement of a viscosity of glass at the liquidus temperature by a platinum sphere pull up method.

Twelfth, the tempered glass of the present invention preferably has a temperature at 10^{4.0} dPa·s of 1,300° C. or less. Herein, the phrase “temperature at 10^{4.0} dPa·s” refers to a value obtained through measurement by a platinum sphere pull up method.

Thirteenth, the tempered glass of the present invention preferably has a thermal expansion coefficient in a temperature range of from 30 to 380° C. of 95×10⁻⁷/° C. or less. Herein, the phrase “thermal expansion coefficient in a temperature range of from 30 to 380° C.” refers to a value obtained by measuring an average thermal expansion coefficient with a dilatometer.

Fourteenth, a tempered glass sheet of the present invention comprises the tempered glass.

Fifteenth, the tempered glass sheet of the present invention is preferably subjected to scribe cutting after tempering.

Sixteenth, a tempered glass sheet of the present invention is a tempered glass sheet having a length dimension of 500 mm or more, a width dimension of 300 mm or more, and a thickness of from 0.5 to 2.0 mm, and preferably has a compression stress value of a compression stress layer of 300 MPa or more and a thickness of the compression stress layer of 10 μm or more. Herein, the “compression stress value of the compression stress layer” and the “thickness of the compression stress layer” refer to values calculated from the number of interference fringes and intervals therebetween, the interference fringes being observed when a sample is observed using a surface stress meter (for example, FSM-6000 manufactured by TOSHIBA CORPORATION).

Seventeenth, the tempered glass sheet of the present invention is preferably formed by an overflow down-draw method. Herein, the “overflow down-draw method” refers to a method comprising causing a molten glass to overflow from both sides of a heat-resistant forming trough, and subjecting the overflowing molten glasses to down-draw downward while the molten glasses are joined at the lower end of the forming trough, to thereby manufacture a glass sheet. In the overflow down-draw method, surfaces that are to serve as the surfaces of the glass sheet are formed in a state of free surfaces without being brought into contact with the surface of the forming trough. Accordingly, a glass sheet having satisfactory surface quality in an unpolished state can be manufactured at low cost.

Eighteenth, the tempered glass sheet of the present invention is preferably free of surface flaws, or when the tempered glass sheet has surface flaws, the number of surface flaws each having a length of 10 μm or more is preferably 120/cm² or less. Herein, the “surface flaw” refers to a flaw in an effective surface excluding a cut surface and a chamfer, and can be visually observed by, for example, irradiation with light of from 1,000 to 10,000 lux in a dark room.

Nineteenth, the tempered glass sheet of the present invention is preferably used for a touch panel display.

Twentieth, the tempered glass sheet of the present invention is preferably used for a cover glass for a cellular phone.

Twenty-first, the tempered glass sheet of the present invention is preferably used for a cover glass for a solar battery.

Twenty-second, the tempered glass sheet of the present invention is preferably used for a protective member for a display.

Twenty-third, a tempered glass sheet of the present invention is a tempered glass sheet having a length dimension of 500 mm or more, a width dimension of 300 mm or more, and a thickness of from 0.3 to 2.0 mm, characterized in that: the tempered glass sheet is free of surface flaws, or when the tempered glass sheet has surface flaws, the number of surface flaws each having a length of 10 μm or more is 120/cm² or less; the tempered glass sheet comprises as a glass composition, in terms of mol %, 50 to 77% of SiO₂, 6.5 to 15% of Al₂O₃, 0.01 to 10% of B₂O₃, 0 to 1% of Li₂O, 9.0 to 15.5% of Na₂O, 9 to 15.5% of Li₂O+Na₂O+K₂O, 0 to 2% of CaO, 0 to 6.5% of MgO+CaO+SrO+BaO, 15.5 to 22% of Li₂O+Na₂O+K₂O+MgO+CaO+SrO+BaO, and to 0.1% of P₂O₅, has a molar ratio B₂O₃/(B₂O₃+Li₂O+Na₂O+K₂O+MgO+CaO+SrO+BaO) of 0.06 to 0.35, and is substantially free of As₂O₃, Sb₂O₃, PbO, and F; and the tempered glass sheet has a density of 2.45 g/cm³ or less, a compression stress value of a compression stress layer of 300 MPa or more, a thickness of the compression stress layer of 10 μm or more, a liquidus temperature of 1,200° C. or less, a thermal expansion coefficient in a temperature range of from 30 to 380° C. of 95×10⁻⁷/° C. or less, and a crack resistance before tempering treatment of 300 gf or more.

Twenty-fourth, a glass to be tempered of the present invention is characterized by comprising as a glass composition, in terms of mol %, 50 to 80% of SiO₂, 5 to 30% of Al₂O₃, 0 to 2% of Li₂O, and 5 to 25% of Na₂O, and being substantially free of As₂O₃, Sb₂O₃, PbO, and F.

Twenty-fifth, the glass to be tempered of the present invention preferably has a crack resistance of 300 gf or more.

### DESCRIPTION OF EMBODIMENTS

A tempered glass according to one embodiment of the present invention has a compression stress layer in a surface thereof. A method of forming the compression stress layer in the surface includes a physical tempering method and a chemical tempering method. The tempered glass of this embodiment is preferably produced by the chemical tempering method.

The chemical tempering method is a method involving introducing alkali ions each having a large ion radius into the surface of glass by ion exchange treatment at a temperature equal to or lower than a strain point of the glass. When the chemical tempering method is used to form a compression stress layer, the compression stress layer can be properly formed even in the case where the thickness of the glass is small. In addition, even when a tempered glass is cut after the formation of the compression stress layer, the tempered glass does not easily break unlike a tempered glass produced by applying a physical tempering method such as an air cooling tempering method.

The tempered glass of this embodiment comprises as a glass composition, in terms of mol %, 50 to 80% of SiO₂, 5 to 30% of Al₂O₃, 0 to 2% of Li₂O, and 5 to 25% of Na₂O, and is substantially free of As₂O₃, Sb₂O₃, PbO, and F. The reasons why the content range of each component is controlled in the above-mentioned range are described below. It should be noted that in the description of the content range of each component, the expression “%” means “mol %” as long as there is no particular comment.

SiO₂ is a component that forms a network of glass, and the content of SiO₂ is from 50 to 80%, preferably from 55 to 77%, more preferably from 57 to 75%, more preferably from 58 to 74%, more preferably from 60 to 73%, particularly preferably from 62 to 72%. When the content of SiO₂ is too small in glass, vitrification does not occur easily, the thermal expansion coefficient becomes too high, and the thermal shock resistance easily lowers. On the other hand, when the content of SiO₂ is too large in glass, the meltability and formability easily lower, and the thermal expansion coefficient becomes too low, with the result that it becomes difficult to match the thermal expansion coefficient with those of peripheral materials.

Al₂O₃ is a component that enhances the ion exchange performance of glass and a component that enhances the strain point or Young's modulus, and the content of Al₂O₃ is from 5 to 30%. When the content of Al₂O₃ is too small in glass, the ion exchange performance may not be exerted sufficiently. Thus, the lower limit range of Al₂O₃ is preferably 5.5% or more, more preferably 6% or more, more preferably 6.5% or more, more preferably 7% or more, more preferably 8% or more, particularly preferably 9% or more. On the other hand, when the content of Al₂O₃ is too large in glass, devitrified crystals are easily deposited in the glass, and it becomes difficult to form a glass sheet by an overflow down-draw method, or the like. In particular, when a glass sheet is formed by an overflow down-draw method through use of a forming trough of alumina, a devitrified crystal of spinel is easily deposited at an interface between the glass sheet and the forming trough of alumina. Further, the thermal expansion coefficient of the glass becomes too low, and it becomes difficult to match the thermal expansion coefficient with those of peripheral materials. In addition, acid resistance also lowers, which makes it difficult to apply the tempered glass to an acid treatment step. Particularly in a system in which a touch sensor is formed on a cover glass, a glass sheet is also simultaneously subjected to chemical treatment. In this case, when its acid resistance is low, a problem is liable to occur in an etching step for a film of ITO or the like. Further, viscosity at high temperature increases, which is liable to lower meltability. Thus, the upper limit range of the content of Al₂O₃ is preferably 25% or less, more preferably 20% or less, more preferably 18% or less, more preferably 16% or less, more preferably 15% or less, more preferably 14% or less, more preferably 13% or less, more preferably 12.5% or less, more preferably 12% or less, more preferably 11.5% or less, more preferably 11% or less, more preferably 10.5% or less, particularly preferably 10% or less.

Li₂O is an ion exchange component and is a component that lowers the viscosity at high temperature of glass to increase the meltability and the formability, and increases the Young's modulus. Further, Li₂O has a great effect of increasing the compression stress value of glass among alkali metal oxides, but when the content of Li₂O becomes extremely large in a glass system containing Na₂O at 7% or more, the compression stress value tends to lower contrarily. Further, when the content of Li₂O is too large in glass, the liquidus viscosity lowers, easily resulting in the denitrification of the glass, and the thermal expansion coefficient becomes too high, with the result that the thermal shock resistance lowers and it becomes difficult to match the thermal expansion coefficient with those of peripheral materials. In addition, the viscosity at low temperature of the glass becomes too low, and the stress relaxation occurs easily, with the result that the compression stress value lowers contrarily in some cases. Thus, the upper limit range of the content of Li₂O is 2% or less, and is preferably 1.7% or less, more preferably 1.5% or less, more preferably 1% or less, more preferably less than 1.0%, more preferably 0.5% or less, more preferably 0.3% or less, more preferably 0.2% or less, particularly preferably 0.1% or less. It should be noted that when Li₂O is added, the addition amount thereof (lower limit of the content of Li₂O) is preferably 0.005% or more, more preferably 0.01% or more, particularly preferably 0.05% or more.

Na₂O is an ion exchange component and is a component that lowers the viscosity at high temperature of glass to increase the meltability and formability. Na₂O is also a component that improves the denitrification resistance of glass. When the content of Na₂O is too small in glass, the meltability lowers, the thermal expansion coefficient lowers, and the ion exchange performance is liable to lower. Thus, the lower limit range of the content of Na₂O is 5% or more, preferably 7% or more, more preferably more than 7.0%, more preferably 8% or more, particularly preferably 9% or more. On the other hand, when the content of Na₂O is too large in glass, there is a tendency that the thermal expansion coefficient becomes too high, with the result that the thermal shock resistance lowers, it becomes difficult to match the thermal expansion coefficient with those of peripheral materials, and the density increases. Further, the strain point lowers excessively, and the glass composition loses its component balance, with the result that the denitrification resistance lowers contrarily in some cases. Thus, the upper limit range of the content of Na₂O is 25% or less, and is preferably 23% or less, preferably 21% or less, more preferably 19% or less, more preferably 18.5% or less, more preferably 17.5% or less, more preferably 17% or less, more preferably 16% or less, more preferably 15.5% or less, more preferably 14% or less, more preferably 13.5% or less, particularly preferably 13% or less.

For example, the following components other than the components may be added to the tempered glass of this embodiment.

The content of B₂O₃ is preferably from 0 to 15%. B₂O₃ is a component that lowers the viscosity at high temperature and density of glass, stabilizes the glass for a crystal to be unlikely precipitated, and lowers the liquidus temperature of the glass. In addition, B₂O₃ is a component that enhances crack resistance to enhance flaw resistance. Thus, the lower limit range of the content of B₂O₃ is preferably 0.01% or more, more preferably 0.1% or more, more preferably 0.5% or more, more preferably 0.7% or more, more preferably 1% or more, more preferably 2% or more, particularly preferably 3% or more. However, when the content of B₂O₃ is too large, through ion exchange, coloring on the surface of glass called weathering may occur, water resistance may lower, and the thickness of a compression stress layer is liable to decrease. Thus, the upper limit range of the content of B₂O₃ is preferably 14% or less, more preferably 13% or less, more preferably 12% or less, more preferably 11% or less, more preferably less than 10.5%, more preferably 10% or less, more preferably 9% or less, more preferably 8% or less, more preferably 7% or less, more preferably 6% or less, particularly preferably 4.9% or less.

The molar ratio B₂O₃/Al₂O₃ is preferably from 0 to 1, more preferably from 0.1 to 0.6, more preferably from 0.12 to 0.5, more preferably from 0.142 to 0.37, more preferably from 0.15 to 0.35, more preferably from 0.18 to 0.32, particularly preferably from 0.2 to 0.3. This allows both devitrification resistance and ion exchange performance to be achieved at high levels while viscosity at high temperature is optimized.

The molar ratio B₂O₃/(Na₂O+Al₂O₃) is preferably from 0 to 1, more preferably from 0.01 to 0.5, more preferably from 0.02 to 0.4, more preferably from 0.03 to 0.3, more preferably from 0.03 to 0.2, more preferably from 0.04 to 0.18, more preferably from 0.05 to 0.17, more preferably from 0.06 to 0.16, particularly preferably from 0.07 to 0.15. This allows both the devitrification resistance and ion exchange performance to be achieved at high levels while the viscosity at high temperature is optimized.

K₂O is a component that promotes ion exchange and is a component that allows the thickness of a compression stress layer to be easily enlarged among alkali metal oxides. K₂O is also a component that lowers the viscosity at high temperature of glass to increase the meltability and formability. K₂O is also a component that improves devitrification resistance. However, when the content of K₂O is too large, the thermal expansion coefficient of glass becomes too large, the thermal shock resistance of the glass lowers, and it becomes difficult to match the thermal expansion coefficient with those of peripheral materials. Further, the strain point lowers excessively, and the glass composition loses its component balance, with the result that the denitrification resistance tends to lower contrarily. Thus, the upper limit range of the content of K₂O is preferably 10% or less, preferably 9% or less, more preferably 8% or less, more preferably 7% or less, more preferably 6% or less, more preferably 5% or less, more preferably 4% or less, more preferably 3% or less, more preferably 2.5% or less, particularly preferably less than 2%. It should be noted that when K₂O is added, the suitable addition amount (lower limit of the content of K₂O) is preferably 0.1% or more, more preferably 0.5% or more, particularly preferably 1% or more. In addition, when the addition of K₂O is avoided as much as possible, the content of K₂O is preferably from 0 to 1.9%, more preferably from 0 to 1.35%, more preferably from 0 to 1%, more preferably from 0 to less than 1%, particularly preferably from 0 to 0.05%.

When the content of Li₂O+Na₂O+K₂O is excessively low, the ion exchange performance and the meltability are liable to lower. On the other hand, when the content of Li₂O+Na₂O+K₂O is excessively high, there is a tendency that the thermal expansion coefficient increases excessively, with the result that the thermal shock resistance lowers, it becomes difficult to match the thermal expansion coefficient with those of peripheral materials, and the density increases. There is also a tendency that the strain point lowers excessively and the component balance of the glass composition is lost, with the result that the denitrification resistance lowers contrarily. Thus, the lower limit range of the content of Li₂O+Na₂O+K₂O is preferably 5% or more, more preferably 6% or more, more preferably 7% or more, more preferably 8% or more, more preferably 9% or more, more preferably 10% or more, more preferably 11% or more, particularly preferably 12% or more. The upper limit range of the content of Li₂O+Na₂O+K₂O is preferably 30% or less, more preferably 25% or less, more preferably 20% or less, more preferably 19% or less, more preferably 18.5% or less, more preferably 17.5% or less, more preferably 16% or less, more preferably 15.5% or less, more preferably 15% or less, more preferably 14.5% or less, particularly preferably 14% or less.

MgO is a component that reduces the viscosity at high temperature of glass to enhance the meltability and formability, and increases the strain point and Young's modulus, and is a component that has a great effect of enhancing the ion exchange performance among alkaline earth metal oxides. Thus, the lower limit range of the content of MgO is preferably 0% or more, more preferably 0.5% or more, more preferably 1% or more, more preferably 1.5% or more, more preferably 2% or more, more preferably 2.5% or more, more preferably 3% or more, more preferably 4% or more, particularly preferably 4.5% or more. However, when the content of MgO is too large in glass, the density and thermal expansion coefficient easily increase, and the devitrification of the glass tends to occur easily. Particularly when a glass sheet is formed by an overflow down-draw method using a forming trough of alumina, a devitrified crystal of spinel is easily deposited at an interface with the forming trough of alumina. Thus, the upper limit range of the content of MgO is preferably 10% or less, more preferably 9% or less, more preferably 8% or less, more preferably 7% or less, more preferably 6% or less, particularly preferably 5% or less.

CaO has greater effects of reducing the viscosity at high temperature of glass to enhance the meltability and formability and increasing the strain point and Young's modulus without involving a reduction in devitrification resistance as compared with other components. However, when the content of CaO is too large in glass, the density and thermal expansion coefficient increase, and the glass composition loses its component balance, with the results that the glass is liable to denitrify contrarily, the ion exchange performance lowers, and the deterioration of an ion exchange solution tends to occur easily. Thus, the content of CaO is preferably from 0 to 6%, more preferably from 0 to 5%, more preferably from 0 to 4%, more preferably from 0 to 3.5%, more preferably from 0 to 3%, more preferably from 0 to 2%, more preferably from 0 to 1%, particularly preferably from 0 to 0.5%.

SrO is a component that reduces the viscosity at high temperature of glass to enhance the meltability and formability, and increases the strain point and Young's modulus. However, when the content thereof is too large in glass, an ion exchange reaction is liable to be inhibited, and moreover, the density and thermal expansion coefficient increase, and the devitrification of the glass occurs easily. Thus, the content of SrO is preferably from 0 to 1.5%, more preferably from 0 to 1%, more preferably from 0 to 0.5%, more preferably from 0 to 0.1%, particularly preferably from 0 to less than 0.1%.

BaO is a component that reduces the viscosity at high temperature of glass to enhance the meltability and formability, and increases the strain point and Young's modulus. However, when the content of BaO is too large in glass, an ion exchange reaction is liable to be inhibited, and moreover, the density and thermal expansion coefficient increase, and the devitrification of the glass occurs easily. Thus, the content of BaO is preferably from 0 to 6%, more preferably from 0 to 3%, more preferably from 0 to 1.5%, more preferably from 0 to 1%, more preferably from 0 to 0.5%, more preferably from 0 to 0.1%, particularly preferably from 0 to less than 0.1%.

When the content of MgO+CaO+SrO+BaO is excessively high, there is a tendency that the density and the thermal expansion coefficient increase, the glass devitrifies, and the ion exchange performance lowers. Thus, the content of MgO+CaO+SrO+BaO is preferably from 0 to 9.9%, more preferably from 0 to 8%, more preferably from 0 to 7%, more preferably from 0 to 6.5%, more preferably from 0 to 6%, more preferably from 0 to 5.5%, particularly preferably from 0 to 5%.

When the content of Li₂O+Na₂O+K₂O+MgO+CaO+SrO+BaO is excessively low, the meltability is liable to lower. Thus, the lower limit range of the content of Li₂O+Na₂O+K₂O+MgO+CaO+SrO+BaO is preferably 10% or more, more preferably 12% or more, more preferably 13% or more, more preferably 14% or more, more preferably 15% or more, more preferably 15.5% or more, more preferably 16% or more, more preferably 17% or more, particularly preferably 17.5% or more. On the other hand, when the content of Li₂O+Na₂O+K₂O+MgO+CaO+SrO+BaO is excessively high, there is a tendency that the density and the thermal expansion coefficient increase, and the ion exchange performance lowers. Thus, the upper limit range of the content of Li₂O+Na₂O+K₂O+MgO+CaO+SrO+BaO is preferably 30% or less, more preferably 28% or less, more preferably 25% or less, more preferably 24% or less, more preferably 23% or less, more preferably 22% or less, more preferably 21% or less, particularly preferably 20% or less.

When a molar ratio B₂O₃/(B₂O₃+Li₂O+Na₂O+K₂O+MgO+CaO+SrO+BaO) reduces, the crack resistance is liable to lower, and the density and the thermal expansion coefficient are liable to increase. On the other hand, when the molar ratio B₂O₃/(B₂O₃+Li₂O+Na₂O+K₂O+MgO+CaO+SrO+BaO) increases, the denitrification resistance is liable to lower, the glass is liable to undergo phase separation, and the ion exchange performance is liable to lower. Thus, the molar ratio B₂O₃/(B₂O₃+Li₂O+Na₂O+K₂O+MgO+CaO+SrO+BaO) is preferably from 0.001 to 0.5, more preferably from 0.005 to 0.45, more preferably from 0.01 to 0.4, more preferably from 0.03 to 0.35, particularly preferably from 0.06 to 0.35.

TiO₂ is a component that enhances the ion exchange performance of glass and is a component that reduces the viscosity at high temperature. However, when the content of TiO₂ is too large in glass, the glass is liable to be colored and to denitrify. Thus, the content of TiO₂ is preferably from 0 to 4.5%, more preferably from 0 to 1%, more preferably from 0 to 0.5%, more preferably from 0 to 0.3%, more preferably from 0 to 0.1%, more preferably from 0 to 0.05%, particularly preferably from 0 to 0.01%.

ZrO₂ is a component that remarkably enhances the ion exchange performance of glass, and is a component that increases the viscosity of glass around the liquidus viscosity and the strain point. Thus, the lower limit range of the content of ZrO₂ is preferably 0.001% or more, more preferably 0.005% or more, more preferably 0.01% or more, particularly preferably 0.05% or more. However, when the content of ZrO₂ is excessively high, there is a risk that the denitrification resistance may lower markedly and the crack resistance may lower, and there is also a risk that the density may increase excessively. Thus, the upper limit range of ZrO₂ is preferably 5% or less, more preferably 4% or less, more preferably 3% or less, more preferably 2% or less, more preferably 1% or less, more preferably 0.5% or less, more preferably 0.3% or less, particularly preferably 0.1% or less.

ZnO is a component that enhances the ion exchange performance of glass and is a component that has a great effect of increasing the compression stress value, in particular. Further, ZnO is a component that reduces the viscosity at high temperature of glass without reducing the viscosity at low temperature. However, when the content of ZnO is too large in glass, there is a tendency that the glass undergoes phase separation, the denitrification resistance lowers, the density increases, and the thickness of the compression stress layer in the glass decreases. Thus, the content of ZnO is preferably from 0 to 6%, more preferably from 0 to 5%, more preferably from 0 to 3%, particularly preferably from 0 to 1%.

P₂O₅ is a component that enhances the ion exchange performance of glass and is a component that increases the thickness of the compression stress layer, in particular. However, when the content of P₂O₅ is too large in glass, the glass undergoes phase separation, and the water resistance is liable to lower. Thus, the content of P₂O₅ is preferably from 0 to 10%, more preferably from 0 to 3%, more preferably from 0 to 1%, more preferably from 0 to 0.5%, particularly preferably from 0 to 0.1%.

As a fining agent, one kind or two or more kinds selected from the group consisting of Cl, SO₃, and CeO₂ (preferably the group consisting of Cl and SO₃) may be added at 0 to 3%.

SnO₂ has an effect of enhancing ion exchange performance. Thus, the content of SnO₂ is preferably from 0 to 3%, more preferably from 0.01 to 3%, more preferably from 0.05 to 3%, more preferably from 0.1 to 3%, particularly preferably from 0.2 to 3%.

The content of SnO₂+SO+Cl is preferably from 0.01 to 3%, more preferably from 0.05 to 3%, more preferably from 0.1 to 3%, particularly preferably from 0.2 to 3% from the viewpoint of simultaneously achieving a fining effect and an effect of enhancing ion exchange performance. It should be noted that the term “SnO₂+SO+Cl” refers to the total amount of SnO₂, Cl, and SO₃.

The content of Fe₂O₃ is preferably less than 1,000 ppm (less than 0.1%), more preferably less than 800 ppm, more preferably less than 600 ppm, more preferably less than 400 ppm, particularly preferably less than 300 ppm. Further, the molar ratio Fe₂O₃/(Fe₂O₃+SnO₂) is controlled to preferably 0.8 or more, more preferably 0.9 or more, particularly preferably 0.95 or more, while the content of Fe₂O₃ is controlled in the above-mentioned range. As a result, the transmittance (400 nm to 770 nm) of glass having a thickness of 1 mm is likely to improve (by, for example, 90% or more).

A rare earth oxide such as Nb₂O₅ or La₂O₃ is a component that enhances the Young's modulus. However, the cost of the raw material itself is high, and when the rare earth oxide is added in a large amount, the denitrification resistance is liable to deteriorate. Thus, the content of the rare earth oxide is preferably 3% or less, more preferably 2% or less, more preferably 1% or less, more preferably 0.5% or less, particularly preferably 0.1% or less.

The tempered glass of this embodiment is substantially free of As₂O₃, Sb₂O₃, PbO, and F as a glass composition from the standpoint of environmental considerations. In addition, the tempered glass is preferably substantially free of Bi₂O₃ from the standpoint of environmental considerations. The gist of the phrase “substantially free of Bi₂O₃” resides in that Bi₂O₃ is not added positively as a glass component, but contamination with Bi₂O₃ as an impurity is allowable. Specifically, the phrase means that the content of Bi₂O₃ is less than 0.05%.

In the tempered glass of this embodiment, the suitable content range of each component can be appropriately selected to attain a suitable glass composition range. Of those, particularly suitable glass composition ranges are as described below.

(1) A glass composition comprising, in terms of mol %, 50 to 80% of SiO₂, 5 to 30% of Al₂O₃, 0 to 1.7% of Li₂O, more than 7.0 to 25% of Na₂O, and 0 to 1% of P₂O₅, and being substantially free of As₂O₃, Sb₂O₃, PbO, and F.
(2) A glass composition comprising, in terms of mol %, 50 to 80% of SiO₂, 6.5 to 15% of Al₂O₃, 0 to 1.7% of Li₂O, more than 7.0 to 15.5% of Na₂O, 0 to 2% of CaO, and 0 to 1% of P₂O₅, and being substantially free of As₂O₃, Sb₂O₃, PbO, and F.
(3) A glass composition comprising, in terms of mol %, 50 to 80% of SiO₂, 6.5 to 15% of Al₂O₃, 0 to 1% of Li₂O, 9 to 15.5% of Na₂O, 0 to 2% of CaO, 0 to 6.5% of MgO+CaO+SrO+BaO, and 0 to 0.1% of P₂O₅, and being substantially free of As₂O₃, Sb₂O₃, PbO, and F.
(4) A glass composition comprising, in terms of mol %, 50 to 80% of SiO₂, 6.5 to 15% of Al₂O₃, 0.01 to 15% of B₂O₃, 0 to 1% of Li₂O, 9 to 15.5% of Na₂O, 9 to 15.5% of Li₂O+Na₂O+K₂O, 0 to 2% of CaO, 0 to 6.5% of MgO+CaO+SrO+BaO, and 0 to 0.1% of P₂O₅, and being substantially free of As₂O₃, Sb₂O₃, PbO, and F.
(5) A glass composition comprising, in terms of mol %, 50 to 80% of SiO₂, 6.5 to 15% of Al₂O₃, 0.01 to 15% of B₂O₃, 0 to 1% of Li₂O, 9 to 15.5% of Na₂O, 9 to 15.5% of Li₂O+Na₂O+K₂O, 0 to 2% of CaO, 0 to 6.5% of MgO+CaO+SrO+BaO, 15.5 to 22% of Li₂O+Na₂O+K₂O+MgO+CaO+SrO+BaO, and 0 to 0.1% of P₂O₅, and being substantially free of As₂O₃, Sb₂O₃, PbO, and F.
(6) A glass composition comprising, in terms of mol %, 50 to 80% of SiO₂, 6.5 to 15% of Al₂O₃, 0.01 to 10% of B₂O₃, 0 to 1% of Li₂O, 9.0 to 15.5% of Na₂O, 9 to 15.5% of Li₂O+Na₂O+K₂O, 0 to 2% of CaO, to 6.5% of MgO+CaO+SrO+BaO, 15.5 to 22% of Li₂O+Na₂O+K₂O+MgO+CaO+SrO+BaO, and 0 to 0.1% of P₂O₅, having a molar ratio B₂O₃/(B₂O₃+Li₂O+Na₂O+K₂O+MgO+CaO+SrO+BaO) of from 0.06 to 0.35, and being substantially free of As₂O₃, Sb₂O₃, PbO, and F.

The tempered glass of this embodiment preferably has the following properties, for example.

In the tempered glass of this embodiment, the compression stress value of the compression stress layer is preferably 300 MPa or more, more preferably 400 MPa or more, more preferably 500 MPa or more, more preferably 600 MPa or more, particularly preferably from 900 to 1,500 MPa. As the compression stress value becomes larger, the mechanical strength of the tempered glass becomes higher. It should be noted that there is a tendency that the compression stress value is increased by increasing the content of Al₂O₃, TiO₂, ZrO₂, MgO, or ZnO in the glass composition or by decreasing the content of SrO or BaO in the glass composition. Further, there is a tendency that the compression stress value is increased by shortening a time necessary for ion exchange or by decreasing the temperature of an ion exchange solution.

The thickness of the compression stress layer is preferably 10 μm or more, more preferably 15 μm or more, more preferably 20 μm or more and less than 80 μm, particularly preferably 30 μm or more and 60 μm or less. As the thickness of the compression stress layer becomes larger, the tempered glass is more hardly cracked even when the tempered glass has a deep flaw, and a variation in the mechanical strength of the tempered glass becomes smaller. Meanwhile, in the case where cutting after tempering is performed, when the thickness of the compression stress layer is excessively large, in the creation of an initial cut into a glass substrate, the initial cut hardly penetrates the compression stress layer to reach an inner region. Thus, in this case, the thickness of the compression stress layer is preferably 100 μm or less, more preferably 70 μm or less, more preferably 60 μm or less, more preferably 50 μm or less, more preferably less than 50 μm, more preferably 45 μm or less, particularly preferably 40 μm or less. It should be noted that there is a tendency that the thickness of the compression stress layer is increased by increasing the content of K₂O or P₂O₅ in the glass composition or by decreasing the content of SrO or BaO in the glass composition. Further, there is a tendency that the thickness of the compression stress layer is increased by lengthening a time necessary for ion exchange or by increasing the temperature of an ion exchange solution.

The tempered glass of this embodiment has a density of preferably 2.6 g/cm³ or less, more preferably 2.55 g/cm³ or less, more preferably 2.50 g/cm³ or less, more preferably 2.48 g/cm³ or less, particularly preferably 2.45 g/cm³ or less. As the density becomes smaller, the weight of the tempered glass can be reduced more. It should be noted that the density is easily reduced by increasing the content of SiO₂, B₂O₃, or P₂O₅ in the glass composition or by decreasing the content of an alkali metal oxide, an alkaline earth metal oxide, ZnO, ZrO₂, or TiO₂ in the glass composition.

The tempered glass of this embodiment has a thermal expansion coefficient in a temperature range of from 30 to 380° C. of preferably 100×10⁻⁷/° C. or less, more preferably 95×10⁻⁷/° C. or less, more preferably 93×10⁻⁷/° C. or less, more preferably 90×10⁻⁷/° C. or less, more preferably 88×10⁻⁷/° C. or less, more preferably 85×10⁻⁷/° C. or less, more preferably 83×10⁻⁷/° C. or less, particularly preferably 82×10⁻⁷/° C. or less. When the thermal expansion coefficient is regulated within the above-mentioned range, breakage due to a thermal shock hardly occurs, and hence the time required for preheating before tempering treatment or annealing after the tempering treatment can be shortened. As a result, the manufacturing cost of the tempered glass can be reduced. In addition, the thermal expansion coefficient can be easily matched with that of a member such as a metal or an organic adhesive, which makes it easy to prevent the detachment of the member such as the metal or the organic adhesive. It should be noted that an increase in the content of an alkali metal oxide or alkaline earth metal oxide in the glass composition is likely to increase the thermal expansion coefficient, and conversely, a reduction in the content of the alkali metal oxide or alkaline earth metal oxide is likely to lower the thermal expansion coefficient.

The tempered glass of this embodiment has a temperature at 10^{4.0} dPa·s of preferably 1,300° C. or less, more preferably 1,280° C. or less, more preferably 1,250° C. or less, more preferably 1,220° C. or less, particularly preferably 1,200° C. or less. As the temperature at 10^{4.0} dPa·s becomes lower, a burden on a forming facility is reduced more, the forming facility has a longer life, and consequently, the manufacturing cost of the tempered glass is more likely to be reduced. The temperature at 10^{4.0} dPa·s is easily decreased by increasing the content of an alkali metal oxide, an alkaline earth metal oxide, ZnO, B₂O₃, or TiO₂ or by reducing the content of SiO₂ or Al₂O₃.

The tempered glass this embodiment has a temperature at 10^{2.5} dPa·s of preferably 1,650° C. or less, more preferably 1,600° C. or less, more preferably 1,580° C. or less, particularly preferably 1,550° C. or less. As the temperature at 10^{2.5} dPa·s becomes lower, melting at lower temperature can be carried out, and hence a burden on glass manufacturing equipment such as a melting furnace is reduced more, and the bubble quality of glass is improved more easily. That is, as the temperature at 10^{2.5} dPa·s becomes lower, the manufacturing cost of the tempered glass is more likely to be reduced. Herein, the “temperature at 10^{2.5} dPa·s” can be measured by, for example, a platinum sphere pull up method. It should be noted that the temperature at 10^{2.5} dPa·s corresponds to a melting temperature. In addition, an increase in the content of an alkali metal oxide, alkaline earth metal oxide, ZnO, B₂O₃, or TiO₂ in the glass composition or a reduction in the content of SiO₂ or Al₂O₃ is likely to lower the temperature at 10^{2.5} dPa·s.

The tempered glass of this embodiment has a liquidus temperature of preferably 1,200° C. or less, more preferably 1,150° C. or less, more preferably 1,100° C. or less, more preferably 1,080° C. or less, more preferably 1,050° C. or less, more preferably 1,020° C. or less, particularly preferably 1,000° C. or less. It should be noted that as the liquidus temperature becomes lower, the denitrification resistance and formability are improved more. It should be noted that the liquidus temperature is easily decreased by increasing the content of Na₂O, K₂O, or B₂O₃ in the glass composition or by reducing the content of Al₂O₃, Li₂O, MgO, ZnO, TiO₂, or ZrO₂.

The tempered glass of this embodiment has a liquidus viscosity of preferably 10^{4.0} dPa·s or more, more preferably 10^{4.4} dPa·s or more, more preferably 10^{4.8} dPa·s or more, more preferably 10^{5.0} dPa·s or more, more preferably 10^{5.3} dPa·s or more, more preferably 10^{5.5} dPa·s or more, more preferably 10^{5.7} dPa·s or more, more preferably 10^{5.8} dPa·s or more, particularly preferably 10^{6.0} dPa·s or more. It should be noted that as the liquidus viscosity becomes higher, the denitrification resistance and formability are improved more. Further, the liquidus viscosity is easily increased by increasing the content of Na₂O or K₂O in the glass composition or by reducing the content of Al₂O₃, Li₂O, MgO, ZnO, TiO₂, or ZrO₂ in the glass composition.

The tempered glass of this embodiment has a crack resistance before tempering treatment of preferably 100 gf or more, more preferably 200 gf or more, more preferably 300 gf or more, more preferably 400 gf or more, more preferably 500 gf or more, more preferably 600 gf or more, more preferably 700 gf or more, more preferably 800 gf or more, more preferably 900 gf or more, particularly preferably 1,000 gf or more. As the crack resistance increases, a surface flaw is less liable to be created on the tempered glass, and hence the mechanical strength of the tempered glass is less liable to lower. In addition, the mechanical strength is less liable to vary. In addition, when the crack resistance is high, a lateral crack is hardly generated at the time of cutting such as scribe cutting after tempering, and hence the scribe cutting after tempering can be easily performed appropriately. As a result, the manufacturing cost of a device can be easily reduced.

When the tempered glass is subjected to the scribe cutting, it is preferred that the depth of an initial cut (scribing cut) be larger than the thickness of the compression stress layer and the tempered glass have an internal tensile stress of 100 MPa or less. Further, the internal tensile stress is preferably 80 MPa or less, more preferably 70 MPa or less, more preferably 60 MPa or less, more preferably 40 MPa or less, more preferably 30 MPa or less, more preferably 25 MPa or less, more preferably 23 MPa or less, particularly preferably 20 MPa or less. In addition, scribing is preferably started from a region at a distance of 5 mm or more from one end of the tempered glass, and the scribing is preferably stopped at a region at a distance of 5 mm or more from the other end of the tempered glass. Further, a snapping step is preferably provided after the scribing. With this, an unintended crack is hardly generated at the time of the scribing, and hence the scribe cutting after tempering can be easily performed appropriately. It should be noted that the internal tensile stress can be calculated by the following equation 1.

Internal tensile stress=(compression stress value of compression stress layer×thickness of compression stress layer)/[sheet thickness−2×(thickness of compression stress layer)] <Equation 1>

When the tempered glass is subjected to the cutting, in particular, the scribe cutting, in order to regulate the thickness of the tempered glass to 0.7 mm or less and lower the internal tensile stress, it is preferred to regulate the compression stress value of the compression stress layer to less than 900 MPa or the thickness of the compression stress layer to less than 30 μm. With this, an unintended crack is hardly generated at the time of the cutting.

When the cutting after tempering is performed, it is preferred that the thickness of the compression stress layer be not excessively increased as compared to the compression stress value of the compression stress layer and a lateral crack be hardly generated at the time of the cutting. In consideration of those viewpoints, glass composition ranges suitable for the cutting after tempering are as described below.

(1) A glass composition comprising, in terms of mol %, 50 to 80% of SiO₂, 5 to 16% of Al₂O₃, 0.5 to 11% of B₂O₃, 0 to 1.7% of Li₂O, more than 7.0 to 21% of Na₂O, and 0 to 3% of P₂O₅, being substantially free of As₂O₃, Sb₂O₃, PbO, and F, and having a molar ratio B₂O₃/(B₂O₃+Li₂O+Na₂O+K₂O+MgO+CaO+SrO+BaO) of from 0.001 to 0.5.
(2) A glass composition comprising, in terms of mol %, 50 to 80% of SiO₂, 6.5 to 14% of Al₂O₃, 1 to 8% of B₂O₃, 0 to 1% of Li₂O, 8 to 15.5% of Na₂O, 0 to 1.9% of K₂O, and 0 to 1% of P₂O₅, being substantially free of As₂O₃, Sb₂O₃, PbO, and F, and having a molar ratio B₂O₃/(B₂O₃+Li₂O+Na₂O+K₂O+MgO+CaO+SrO+BaO) of from 0.005 to 0.45.
(3) A glass composition comprising, in terms of mol %, 50 to 80% of SiO₂, 7 to 13% of Al₂O₃, 2 to 8% of B₂O₃, 0 to 1% of Li₂O, 9 to 14% of Na₂O, 0 to 1.9% of K₂O, and 0 to 0.5% of P₂O₅, being substantially free of As₂O₃, Sb₂O₃, PbO, and F, and having a molar ratio B₂O₃/(B₂O₃+Li₂O+Na₂O+K₂O+MgO+CaO+SrO+BaO) of from 0.01 to 0.4.
(4) A glass composition comprising, in terms of mol %, 50 to 80% of SiO₂, 7 to 12.5% of Al₂O₃, 3 to 8% of B₂O₃, 0 to 0.5% of Li₂O, 9 to 14% of Na₂O, 0 to 1.35% of K₂O, 0 to 0.5% of P₂O₅, and 0 to 0.1% of ZrO₂, being substantially free of As₂O₃, Sb₂O₃, PbO, and F, and having a molar ratio B₂O₃/(B₂O₃+Li₂O+Na₂O+K₂O+MgO+CaO+SrO+BaO) of from 0.03 to 0.35.
(5) A glass composition comprising, in terms of mol %, 50 to 80% of SiO₂, 8 to 11.5% of Al₂O₃, 3 to 6% of B₂O₃, 0.0001 to 0.5% of Li₂O, 9 to 14% of Na₂O, 0 to 1.35% of K₂O, 0 to 0.5% of P₂O₅, and 0 to 0.1% of ZrO₂, being substantially free of As₂O₃, Sb₂O₃, PbO, and F, and having a molar ratio B₂O₃/(B₂O₃+Li₂O+Na₂O+K₂O+MgO+CaO+SrO+BaO) of from 0.06 to 0.35.

A tempered glass sheet according to an embodiment of the present invention comprises the tempered glass described above. Thus, technical features (suitable characteristics, suitable component ranges, and the like) of the tempered glass sheet of this embodiment are the same as the technical features of the tempered glass described in the embodiment described above, and hence detailed descriptions thereof are omitted here.

The tempered glass sheet of this embodiment is free of surface flaws, or when the tempered glass sheet has surface flaws, the number of surface flaws each having a length of 10 μm or more is preferably 120/cm² or less, more preferably 100/cm² or less, more preferably 50/cm² or less, more preferably 10/cm² or less, more preferably 5/cm² or less, more preferably 1/cm² or less, more preferably 0.5/cm² or less, particularly preferably 0.1/cm² or less. As the number of surface flaws becomes smaller, the mechanical strength of the tempered glass is less liable to lower and the mechanical strength is less liable to vary. The lengths and number of surface flaws can be calculated by, for example, observation with an electron microscope. It should be noted that when the glass sheet is formed by an overflow down-draw method and its surface is left unpolished, the surface flaws can be reduced to the extent possible.

The surface of the tempered glass sheet of this embodiment has an average surface roughness (Ra) of preferably 10 Å or less, more preferably 8 Å or less, more preferably 6 Å or less, more preferably 4 Å or less, more preferably 3 Å or less, particularly preferably 2 Å or less. As the average surface roughness (Ra) increases, the mechanical strength of the tempered glass sheet tends to become lower. Herein, the average surface roughness (Ra) refers to a value measured by a method in conformity with SEMI D7-97 “FPD Glass Substrate Surface Roughness Measurement Method.”

The tempered glass sheet of this embodiment has a length dimension (longitudinal dimension) of preferably 500 mm or more, more preferably 700 mm or more, more preferably 1,000 mm or more and a width dimension (lateral dimension) of preferably 500 mm or more, more preferably 700 mm or more, more preferably 1,000 mm or more. An increase in the size of the tempered glass sheet enables the tempered glass sheet to be suitably used as a cover glass for the display portion of the display of a large-size TV or the like.

The upper limit range of the sheet thickness of the tempered glass sheet of this embodiment is preferably 2.0 mm or less, more preferably 1.5 mm or less, more preferably 1.3 mm or less, more preferably 1.1 mm or less, more preferably 1.0 mm or less, more preferably 0.8 mm or less, more preferably 0.7 mm or less, more preferably 0.5 mm or less, more preferably 0.45 mm or less, more preferably 0.4 mm or less, particularly preferably 0.35 mm or less. Meanwhile, when the sheet thickness is excessively small, desired mechanical strength is difficult to obtain. Thus, the lower limit range of the sheet thickness is preferably 0.1 mm or more, more preferably 0.2 mm or more, particularly preferably 0.3 mm or more.

A glass to be tempered according to an embodiment of the present invention is a glass to be subjected to tempering treatment, comprising as a glass composition, in terms of mol %, 50 to 80% of SiO₂, 5 to 30% of Al₂O₂, 0 to 2% of Li₂O, and 5 to 25% of Na₂O, and being substantially free of As₂O₃, Sb₂O₂, PbO, and F. Thus, technical features (suitable characteristics, suitable component ranges, and the like) of the glass to be tempered of this embodiment are the same as the technical features of the tempered glass described in the embodiment described above, and hence detailed descriptions thereof are omitted here.

The glass to be tempered of this embodiment has a crack resistance of preferably 100 gf or more, more preferably 200 gf or more, more preferably 300 gf or more, more preferably 400 gf or more, more preferably 500 gf or more, more preferably 600 gf or more, more preferably 700 gf or more, more preferably 800 gf or more, more preferably 900 gf or more, particularly preferably 1,000 gf or more. As the crack resistance increases, a surface flaw is less liable to be created on a tempered glass to be obtained, and hence the mechanical strength of the tempered glass is less liable to lower. In addition, the mechanical strength is less liable to vary. In addition, when the crack resistance is high, a lateral crack is hardly generated at the time of cutting such as scribe cutting after tempering, and hence the scribe cutting after tempering can be easily performed appropriately. As a result, the manufacturing cost of a device can be easily reduced.

When the glass to be tempered of this embodiment is subjected to ion exchange treatment in a KNO₃ molten salt at 430° C., it is preferred that the compression stress value of a compression stress layer in a surface thereof be 300 MPa or more and the thickness of the compression stress layer be 10 μm or more, it is more preferred that the compression stress of the surface thereof be 600 MPa or more and the thickness of the compression stress layer be 30 μm or more, and it is particularly preferred that the compression stress of the surface thereof be 700 MPa or more and the thickness of the compression stress layer be 30 μm or more.

When the ion exchange treatment is performed, the temperature of the KNO₃ molten salt is preferably from 400 to 550° C., and the ion exchange time is preferably from 1 to 10 hours, particularly preferably from 2 to 8 hours. Under the conditions, the compression stress layer can be properly formed easily. It should be noted that the glass to be tempered of this embodiment has the above-mentioned glass composition, and hence the compression stress value and thickness of the compression stress layer can be increased without using a mixture of a KNO₃ molten salt and a NaNO₃ molten salt or the like.

The glass to be tempered, tempered glass, and tempered glass sheet of the present invention can be produced as described below.

First, glass raw materials, which have been blended so as to have the above-mentioned glass composition, are loaded in a continuous melting furnace, are melted by heating at 1,500 to 1,600° C., and are fined. After that, the resultant is fed to a forming apparatus, is formed into a predetermined shape such as a sheet shape, and is annealed to produce a glass sheet or the like. Thus, a glass to be tempered is obtained.

An overflow down-draw method is preferably adopted as a method of forming the glass sheet. The overflow down-draw method is a method by which a high-quality glass sheet can be produced in a large amount, and by which even a large-size glass sheet can be easily produced. In addition, the method allows flaws on the surface of the glass sheet to be reduced to the extent possible. It should be noted that in the overflow down-draw method, alumina or dense zircon is used as a forming trough. The glass to be tempered of this embodiment has satisfactory compatibility with alumina and dense zircon, in particular, alumina (hardly reacts with the forming trough to generate bubbles, glass stones, or the like).

Various forming methods other than the overflow down-draw method may also be adopted. For example, forming methods such as a float method, a down draw method (such as a slot down method or a re-draw method), a roll out method, and a press method may be adopted.

Next, the resultant glass to be tempered is subjected to tempering treatment, thereby being able to produce a tempered glass. The resultant tempered glass may be cut into pieces having predetermined sizes before the tempering treatment, but the cutting is preferably performed after the tempering treatment from the viewpoint of the manufacturing efficiency of a device.

When the tempered glass is cut, in the cut surface, there occurs a region in which the compression stress layer is not formed, and in the region, the mechanical strength is liable to lower. In this case, it is preferred to coat the cut surface with a resin or chamfer the cut surface.

The tempering treatment is preferably ion exchange treatment. Conditions for the ion exchange treatment are not particularly limited, and optimum conditions may be selected in view of, for example, the viscosity properties, applications, thickness, inner tensile stress, and dimensional change of glass. The ion exchange treatment can be performed, for example, by immersing glass in a KNO₃ molten salt at 400 to 550° C. for 1 to 8 hours. Particularly when the ion exchange of K ions in the KNO₃ molten salt with Na components in the glass is performed, it is possible to form efficiently a compression stress layer in a surface of the glass.

### Example 1

The present invention is hereinafter described based on examples. It should be noted that the following examples are merely illustrative. The present invention is by no means limited to these examples.

Tables 1 to 16 show examples of the present invention (sample Nos. 1 to 92).

TABLE 1

| | | Example | | | | | |
|---|---|---|---|---|---|---|---|
| | | No. 1 | No. 2 | No. 3 | No. 4 | No. 5 | No. 6 |
| Glass | SiO₂ | 65.4 | 65.4 | 65.4 | 65.8 | 65.9 | 65.1 |
| composition | Al₂O₃ | 11.5 | 11.5 | 11.5 | 11.6 | 12.2 | 11.5 |
| (mol %) | B₂O₃ | 1.6 | 2.8 | 4.1 | 4.7 | 4.1 | 4.1 |
| | Na₂O | 12.8 | 11.8 | 10.7 | 9.7 | 10.7 | 10.7 |
| | K₂O | 2.6 | 2.4 | 2.2 | 2.0 | 2.2 | 2.2 |
| | MgO | 4.8 | 4.8 | 4.8 | 4.9 | 4.8 | 6.3 |
| | CaO | 1.2 | 1.2 | 1.2 | 1.2 | 0.0 | 0.0 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 15.3 | 14.2 | 12.9 | 11.7 | 12.9 | 12.9 |
| MgO + CaO + SrO + BaO | 6.0 | 6.0 | 6.0 | 6.0 | 4.8 | 6.4 |
| Li₂O + Na₂O + K₂O + MgO + CaO + | 21.3 | 20.1 | 18.9 | 17.8 | 17.6 | 19.2 |
| SrO + BaO | | | | | | |
| B₂O₃/(B₂O₃ + Li₂O + Na₂O + | 0.07 | 0.12 | 0.18 | 0.21 | 0.19 | 0.18 |
| K₂O + MgO + CaO + SrO + BaO) | | | | | | |
| Density (g/cm³) | 2.45 | 2.44 | 2.43 | 2.41 | 2.41 | 2.42 |
| α (×10⁻⁷/° C.) | 89 | 84 | 79 | 74 | 78 | 78 |
| Ps (° C.) | 568 | 568 | 569 | 572 | 581 | 580 |
| Ta (° C.) | 616 | 616 | 618 | 621 | 634 | 630 |
| Ts (° C.) | 857 | 858.5 | 860 | 865.5 | 892 | 876.5 |
| 10⁴ dPa · s (° C.) | 1,248 | 1,247 | 1,258 | 1,262 | 1,297 | 1,260 |
| 10³ dPa · s (° C.) | 1,448 | 1,447 | 1,460 | 1,465 | 1,497 | 1,460 |
| 10^{2.5} dPa · s (° C.) | 1,573 | 1,576 | 1,588 | 1,590 | 1,624 | 1,587 |
| TL(° C.) | 1,021 | 1,085 | 1,113 | 1,144 | Unmea- | Unmea- |
| | | | | | sured | sured |
| log₁₀η_{TL} (dPa · s) | 5.7 | 5.1 | 5.0 | 4.8 | Unmea- | Unmea- |
| | | | | | sured | sured |
| CS (MPa) | 996 | 970 | 902 | 838 | 930 | 909 |
| DOL (μm) | 44 | 41 | 40 | 39 | 45 | 41 |
| Crack resistance (gf) | 500 | 1,000 | 900 | 1,500 | Unmea- | Unmea- |
| | | | | | sured | sured |

TABLE 2

| | | Example | | | | | |
|---|---|---|---|---|---|---|---|
| | | No. 7 | No. 8 | No. 9 | No. 10 | No. 11 | No. 12 |
| Glass | SiO₂ | 65.5 | 65.7 | 64.4 | 65.4 | 66.0 | 66.2 |
| composition | Al₂O₃ | 11.6 | 11.6 | 12.3 | 12.3 | 10.9 | 11.5 |
| (mol %) | B₂O₃ | 4.1 | 4.1 | 4.2 | 3.2 | 4.1 | 3.2 |
| | Na₂O | 11.7 | 10.8 | 10.8 | 10.8 | 10.7 | 10.8 |
| | K₂O | 2.2 | 2.9 | 2.2 | 2.2 | 2.2 | 2.2 |
| | MgO | 4.8 | 4.8 | 4.8 | 4.8 | 4.8 | 4.8 |
| | CaO | 0.0 | 0.0 | 1.2 | 1.2 | 1.2 | 1.2 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 13.9 | 13.7 | 13.1 | 13.0 | 12.9 | 13.0 |
| MgO + CaO + SrO + BaO | 4.8 | 4.8 | 6.0 | 6.0 | 6.0 | 6.0 |
| Li₂O + Na₂O + K₂O + MgO + CaO + | 18.7 | 18.5 | 19.1 | 19.1 | 18.9 | 18.9 |
| SrO + BaO | | | | | | |
| B₂O₃/(B₂O₃ + Li₂O + Na₂O + | 0.18 | 0.18 | 0.18 | 0.14 | 0.18 | 0.14 |
| K₂O + MgO + CaO + SrO + BaO) | | | | | | |
| Density (g/cm³) | 2.42 | 2.42 | 2.43 | 2.43 | 2.43 | 2.43 |
| α (×10⁻⁷/° C.) | 82 | 82 | 78 | 79 | 79 | 79 |
| Ps (° C.) | 564 | 569 | 573 | 581 | 560 | 576 |
| Ta (° C.) | 612 | 619 | 623 | 632 | 607 | 626 |
| Ts (° C.) | 858 | 870.5 | 871 | 884 | 847.5 | 876 |
| 10⁴ dPa · s (° C.) | 1,261 | 1,280 | 1,260 | 1,280 | 1,247 | 1,277 |
| 10³ dPa · s (° C.) | 1,468 | 1,488 | 1,460 | 1,480 | 1,455 | 1,480 |
| 10^{2.5} dPa · s (° C.) | 1,595 | 1,613 | 1,587 | 1,604 | 1,586 | 1,606 |
| TL (° C.) | 1,127 | 1,151 | 1,182 | 1,157 | 1,145 | 1,134 |
| log₁₀η_{TL} (dPa · s) | 4.9 | 4.8 | 4.5 | 4.8 | 4.6 | 4.9 |
| CS (MPa) | 928 | 869 | 909 | 919 | 860 | 895 |
| DOL (μm) | 42 | 47 | 41 | 43 | 39 | 42 |
| Crack resistance (gf) | Unmea- | Unmea- | Unmea- | Unmea- | Unmea- | Unmea- |
| | sured | sured | sured | sured | sured | sured |

TABLE 3

| | | Example | | | | | |
|---|---|---|---|---|---|---|---|
| | | No. 13 | No. 14 | No. 15 | No. 16 | No. 17 | No. 18 |
| Glass | SiO₂ | 65.2 | 64.2 | 64.9 | 65.0 | 66.1 | 68.9 |
| composition | Al₂O₃ | 10.9 | 11.6 | 11.4 | 11.4 | 11.6 | 9.4 |
| (mol %) | MgO | 4.8 | 4.8 | 4.7 | 4.8 | 0.0 | 4.8 |
| | CaO | 1.2 | 1.2 | 0.0 | 0.0 | 0.0 | 0.0 |
| | B₂O₃ | 5.1 | 5.1 | 4.1 | 6.9 | 7.0 | 3.7 |
| | Na₂O | 10.6 | 10.8 | 14.8 | 11.8 | 15.2 | 12.4 |
| | K₂O | 2.1 | 2.2 | 0.0 | 0.0 | 0.0 | 0.7 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 12.8 | 13.0 | 14.8 | 11.8 | 15.2 | 13.1 |
| MgO + CaO + SrO + BaO | 6.0 | 6.0 | 4.8 | 4.8 | 0.0 | 4.8 |
| Li₂O + Na₂O + K₂O + MgO + CaO + | 18.8 | 19.0 | 19.6 | 16.6 | 15.3 | 17.9 |
| SrO + BaO | | | | | | |
| B₂O₃/(B₂O₃ + Li₂O + Na₂O + | 0.21 | 0.21 | 0.17 | 0.29 | 0.31 | 0.17 |
| K₂O + MgO + CaO + SrO + BaO) | | | | | | |
| Density (g/cm³) | 2.42 | 2.42 | 2.43 | 2.39 | 2.41 | 2.41 |
| α (×10⁻⁷/° C.) | 78 | 79 | 92 | 69 | 80 | 78 |
| Ps (° C.) | 555 | 559 | 560 | 563 | 545 | 558 |
| Ta (° C.) | 601 | 606 | 607 | 612 | 587 | 605 |
| Ts (° C.) | 835 | 841.5 | 836 | 853.5 | 789 | 843 |
| 10⁴ dPa · s (° C.) | 1,230 | 1,239 | 1,227 | 1,262 | 1,190 | 1,240 |
| 10³ dPa · s (° C.) | 1,435 | 1,440 | 1,431 | 1,468 | 1,428 | 1,453 |
| 10^{2.5} dPa · s (° C.) | 1,565 | 1,568 | 1,557 | 1,583 | 1,575 | 1,585 |
| TL (° C.) | 1,116 | 1,141 | 1,053 | 1,134 | <893 | 1,044 |
| log₁₀η_{TL} (dPa · s) | 4.7 | 4.6 | 5.2 | 4.8 | >6.2 | 5.4 |
| CS (MPa) | 843 | 861 | 977 | 876 | 828 | 848 |
| DOL (μm) | 36 | 38 | 34 | 31 | 34 | 36 |
| Crack resistance (gf) | Unmea- | Unmea- | Unmea- | Unmea- | Unmea- | Unmea- |
| | sured | sured | sured | sured | sured | sured |

TABLE 4

| | | Example | | | | | |
|---|---|---|---|---|---|---|---|
| | | No. 19 | No. 20 | No. 21 | No. 22 | No. 23 | No. 24 |
| Glass | SiO₂ | 69.4 | 70.4 | 70.9 | 71.9 | 72.5 | 67.0 |
| composition | Al₂O₃ | 9.5 | 8.1 | 8.2 | 6.8 | 6.9 | 9.5 |
| (mol %) | B₂O₃ | 3.7 | 3.7 | 3.7 | 3.6 | 3.6 | 6.5 |
| | Na₂O | 10.4 | 12.3 | 10.3 | 12.2 | 10.2 | 11.4 |
| | K₂O | 2.1 | 0.7 | 2.0 | 0.7 | 2.0 | 0.7 |
| | MgO | 4.8 | 4.7 | 4.8 | 4.7 | 4.7 | 4.8 |
| | CaO | 0.0 | 0.0 | 0.0 | 0.0 | 0.0 | 0.0 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 12.5 | 13.0 | 12.4 | 12.9 | 12.3 | 12.1 |
| MgO + CaO + SrO + BaO | 4.8 | 4.7 | 4.8 | 4.7 | 4.7 | 4.8 |
| Li₂O + Na₂O + K₂O + MgO + CaO + | 17.3 | 17.7 | 17.2 | 17.6 | 17.0 | 16.9 |
| SrO + BaO | | | | | | |
| B₂O₃/(B₂O₃ + Li₂O + Na₂O + | 0.18 | 0.17 | 0.18 | 0.17 | 0.18 | 0.28 |
| K₂O + MgO + CaO + SrO + BaO) | | | | | | |
| Density (g/cm³) | 2.40 | 2.41 | 2.40 | 2.41 | 2.40 | 2.40 |
| α (×10⁻⁷/° C.) | 78 | 77 | 78 | 76 | 76 | 73 |
| Ps (° C.) | 559 | 551 | 554 | 547 | 548 | 550 |
| Ta (° C.) | 608 | 596 | 601 | 591 | 594 | 595 |
| Ts (° C.) | 859 | 823 | 843 | 808 | 826 | 824 |
| 10⁴ dPa · s (° C.) | 1,274 | 1,230 | 1,261 | 1,209 | 1,225 | 1,211 |
| 10³ dPa · s (° C.) | 1,488 | Unmea- | 1,486 | 1,429 | 1,445 | 1,423 |
| | | sured | | | | |
| 10^{2.5} dPa · s (° C.) | 1,631 | Unmea- | 1,622 | 1,573 | 1,585 | 1,556 |
| | | sured | | | | |
| TL (° C.) | 1,074 | 943 | 971 | 959 | 968 | 1,056 |
| log₁₀η_{TL} (dPa · s) | 5.3 | 6.1 | 6.1 | 5.8 | 5.9 | 5.1 |
| CS (MPa) | 781 | 786 | 728 | 725 | 682 | 791 |
| DOL (μm) | 43 | 34 | 40 | 32 | 38 | 29 |
| Crack resistance (gf) | Unmea- | Unmea- | Unmea- | Unmea- | Unmea- | Unmea- |
| | sured | sured | sured | sured | sured | sured |

TABLE 5

| | | Example | | | | |
|---|---|---|---|---|---|---|
| | | No. 25 | No. 26 | No. 27 | No. 28 | No. 29 |
| Glass | SiO₂ | 67.6 | 68.6 | 69.1 | 70.1 | 70.6 |
| composition | Al₂O₃ | 9.5 | 8.1 | 8.2 | 6.8 | 6.9 |
| (mol %) | B₂O₃ | 6.5 | 6.4 | 6.5 | 6.4 | 6.4 |
| | Na₂O | 9.4 | 11.3 | 9.3 | 11.2 | 9.3 |
| | K₂O | 2.1 | 0.7 | 2.0 | 0.7 | 2.0 |
| | MgO | 4.8 | 4.8 | 4.8 | 4.7 | 4.7 |
| | CaO | 0.0 | 0.0 | 0.0 | 0.0 | 0.0 |
| | SnO₂ | 0.1 | 0.1 | 0.1 | 0.1 | 0.1 |

| | | | | | |
|---|---|---|---|---|---|
| Li₂O + Na₂O + K₂O | 11.5 | 12.0 | 11.4 | 11.9 | 11.3 |
| MgO + CaO + SrO + BaO | 4.8 | 4.8 | 4.8 | 4.7 | 4.7 |
| Li₂O + Na₂O + K₂O + MgO + CaO + | 16.3 | 16.8 | 16.2 | 16.6 | 16.1 |
| SrO + BaO | | | | | |
| B₂O₃/(B₂O₃ + Li₂O + Na₂O + | 0.29 | 0.28 | 0.29 | 0.28 | 0.29 |
| K₂O + MgO + CaO + SrO + BaO) | | | | | |
| Density (g/cm³) | 2.39 | 2.40 | 2.39 | 2.40 | 2.39 |
| α (×10⁻⁷/° C.) | 73 | 71 | 71 | 71 | 72 |
| Ps (° C.) | 547 | 541 | 541 | 538 | 537 |
| Ta (° C.) | 594 | 584 | 586 | 579 | 580 |
| Ts (° C.) | 835 | 798 | 818 | 786 | 800 |
| 10⁴ dPa · s (° C.) | 1,245 | 1,189 | 1,217 | 1,167 | 1,216 |
| 10³ dPa · s (° C.) | 1,459 | 1,407 | 1,437 | 1,386 | Unmea- |
| | | | | | sured |
| 10^{2.5} dPa · s (° C.) | 1,592 | 1,541 | 1,577 | 1,526 | Unmea- |
| | | | | | sured |
| TL (° C.) | 1,131 | 1,056 | 1,106 | 999 | 1,016 |
| log₁₀η_{TL} (dPa · s) | 4.7 | 4.9 | 4.7 | 5.1 | 5.4 |
| CS (MPa) | 713 | 771 | 672 | 735 | 636 |
| DOL (μm) | 37 | 27 | 33 | 25 | 31 |
| Crack resistance (gf) | Unmea- | Unmea- | Unmea- | Unmea- | Unmea- |
| | sured | sured | sured | sured | sured |

TABLE 6

| | | Example | | | | | |
|---|---|---|---|---|---|---|---|
| | | No. 30 | No. 31 | No. 32 | No. 33 | No. 34 | No. 35 |
| Glass | SiO₂ | 65.8 | 63.8 | 67.5 | 65.1 | 65.6 | 63.9 |
| composition | Al₂O₃ | 11.4 | 11.4 | 10.0 | 10.1 | 11.4 | 11.4 |
| (mol %) | MgO | 4.7 | 4.8 | 4.6 | 4.8 | 4.7 | 4.8 |
| | B₂O₃ | 2.9 | 4.8 | 2.9 | 4.8 | 2.9 | 4.7 |
| | Na₂O | 12.8 | 12.8 | 12.6 | 12.8 | 15.3 | 15.1 |
| | K₂O | 2.3 | 2.3 | 2.3 | 2.3 | 0.0 | 0.0 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 15.1 | 15.1 | 14.9 | 15.1 | 15.4 | 15.2 |
| MgO + CaO + SrO + BaO | 4.7 | 4.8 | 4.7 | 4.8 | 4.7 | 4.8 |
| Li₂O + Na₂O + K₂O + MgO + CaO + | 19.9 | 19.8 | 19.6 | 19.9 | 20.1 | 19.9 |
| SrO + BaO | | | | | | |
| B₂O₃/(B₂O₃ + Li₂O + Na₂O + | 0.13 | 0.19 | 0.13 | 0.19 | 0.13 | 0.19 |
| K₂O + MgO + CaO + SrO + BaO) | | | | | | |
| Density (g/cm³) | 2.43 | 2.43 | 2.43 | 2.43 | 2.44 | 2.43 |
| α (×10⁻⁷/° C.) | 88 | 89 | 87 | 87 | 84 | 83 |
| Ps (° C.) | 564 | 545 | 553 | 539 | 566 | 551 |
| Ta (° C.) | 614 | 589 | 600 | 582 | 613 | 595 |
| Ts (° C.) | 863 | 815 | 836 | 799 | 849 | 814 |
| 10⁴ dPa · s (° C.) | 1,251 | 1,211 | 1,228 | 1,194 | 1,225 | 1,184 |
| 10³ dPa · s (° C.) | 1,454 | 1,420 | 1,438 | 1,403 | 1,430 | 1,394 |
| 10^{2.5} dPa · s (° C.) | 1,582 | 1,549 | 1,572 | 1,537 | 1,558 | 1,521 |
| TL (° C.) | 1,041 | 1,071 | 1,011 | 1,004 | 1,031 | 1,023 |
| log₁₀η_{TL} (dPa · s) | 5.6 | 4.9 | 5.6 | 5.3 | 5.4 | 5.2 |
| CS (MPa) | 883 | 866 | 823 | 816 | 981 | 932 |
| DOL (μm) | 49 | 42 | 47 | 40 | 36 | 32 |
| Crack resistance (gf) | Unmea- | Unmea- | Unmea- | Unmea- | 1,000 | Unmea- |
| | sured | sured | sured | sured | | sured |

TABLE 7

| | | Example | | | | | |
|---|---|---|---|---|---|---|---|
| | | No. 36 | No. 37 | No. 38 | No. 39 | No. 40 | No. 41 |
| Glass | SiO₂ | 67.0 | 65.2 | 66.8 | 64.7 | 68.4 | 66.2 |
| composition | Al₂O₃ | 10.1 | 10.1 | 12.9 | 12.9 | 11.5 | 11.6 |
| (mol %) | MgO | 4.7 | 4.7 | 1.7 | 1.7 | 1.7 | 1.7 |
| | B₂O₃ | 2.9 | 4.7 | 2.9 | 4.9 | 2.9 | 4.8 |
| | Na₂O | 15.2 | 15.2 | 15.6 | 15.7 | 15.4 | 15.6 |
| | K₂O | 0.0 | 0.0 | 0.0 | 0.0 | 0.0 | 0.0 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 15.2 | 15.2 | 15.6 | 15.7 | 15.5 | 15.6 |
| MgO + CaO + SrO + BaO | 4.7 | 4.7 | 1.7 | 1.7 | 1.7 | 1.7 |
| Li₂O + Na₂O + K₂O + MgO + CaO + | 20.0 | 20.0 | 17.3 | 17.4 | 17.2 | 17.3 |
| SrO + BaO | | | | | | |
| B₂O₃/(B₂O₃ + Li₂O + Na₂O + | 0.13 | 0.19 | 0.15 | 0.22 | 0.15 | 0.22 |
| K₂O + MgO + CaO + SrO + BaO) | | | | | | |
| Density (g/cm³) | 2.43 | 2.43 | 2.42 | 2.42 | 2.42 | 2.42 |
| α (×10⁻⁷/° C.) | 83 | 83 | 83 | 83 | 82 | 82 |
| Ps (° C.) | 556 | 544 | 574 | 556 | 562 | 551 |
| Ta (° C.) | 602 | 586 | 624 | 603 | 609 | 594 |
| Ts (° C.) | 825 | 796 | 877 | 836 | 845 | 813 |
| 10⁴ dPa · s (° C.) | 1,215 | 1,167 | 1,293 | 1,255 | 1,272 | 1,225 |
| 10³ dPa · s (° C.) | 1,426 | 1,371 | 1,504 | 1,472 | 1,496 | 1,449 |
| 10^{2.5} dPa · s (° C.) | 1,557 | 1,505 | 1,642 | 1,606 | 1,636 | 1,587 |
| TL (° C.) | 1,027 | 963 | 1,027 | 1,003 | 1,015 | 1,010 |
| log₁₀η_{TL} (dPa · s) | 5.3 | 5.5 | 5.9 | 5.7 | 5.7 | 5.4 |
| CS (MPa) | 880 | 864 | 987 | 943 | 858 | 857 |
| DOL (μm) | 35 | 30 | 44 | 39 | 43 | 37 |
| Crack resistance (gf) | Unmea- | Unmea- | Unmea- | Unmea- | Unmea- | Unmea- |
| | sured | sured | sured | sured | sured | sured |

TABLE 8

| | | Example | | | | | |
|---|---|---|---|---|---|---|---|
| | | No. 42 | No. 43 | No. 44 | No. 45 | No. 46 | No. 47 |
| Glass | SiO₂ | 65.3 | 65.7 | 65.9 | 66.1 | 65.4 | 65.9 |
| composition | Al₂O₃ | 11.3 | 11.7 | 11.7 | 11.8 | 12.0 | 12.0 |
| (mol %) | MgO | 6.2 | 5.5 | 4.8 | 4.0 | 6.3 | 4.8 |
| | B₂O₃ | 1.9 | 1.8 | 2.2 | 2.7 | 0.9 | 1.9 |
| | Na₂O | 15.2 | 15.2 | 15.3 | 15.3 | 15.3 | 15.3 |
| | K₂O | 0.0 | 0.0 | 0.0 | 0.0 | 0.0 | 0.0 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 15.2 | 15.3 | 15.3 | 15.4 | 15.3 | 15.3 |
| MgO + CaO + SrO + BaO | 6.3 | 5.5 | 4.8 | 4.0 | 6.3 | 4.8 |
| Li₂O + Na₂O + K₂O + MgO + CaO + | 21.5 | 20.8 | 20.1 | 19.4 | 21.6 | 20.1 |
| SrO + BaO | | | | | | |
| B₂O₃/(B₂O₃ + Li₂O + Na₂O + | 0.08 | 0.08 | 0.10 | 0.12 | 0.04 | 0.08 |
| K₂O + MgO + CaO + SrO + BaO) | | | | | | |
| Density (g/cm³) | 2.45 | 2.44 | 2.44 | 2.43 | 2.45 | 2.44 |
| α (×10⁻⁷/° C.) | 83 | 83 | 83 | 83 | 83 | 83 |
| Ps (° C.) | 577 | 581 | 575 | 568 | 598 | 584 |
| Ta (° C.) | 626 | 630 | 624 | 616 | 650 | 634 |
| Ts (° C.) | 862 | 871 | 864 | 855 | 891 | 878 |
| 10⁴ dPa · s (° C.) | 1,238 | 1,247 | 1,248 | 1,247 | 1,265 | 1,265 |
| 10³ dPa · s (° C.) | 1,433 | 1,444 | 1,448 | 1,451 | 1,458 | 1,465 |
| 10^{2.5} dPa · s (° C.) | 1,556 | 1,566 | 1,574 | 1,577 | 1,580 | 1,589 |
| TL (° C.) | Unmea- | 1,119 | 1,070 | 985 | Unmea- | 1,093 |
| | sured | | | | sured | |
| log₁₀η_{TL} (dPa · s) | Unmea- | 4.9 | 5.3 | 6.0 | Unmea- | 5.2 |
| | sured | | | | sured | |
| CS (MPa) | 1,067 | 1,077 | 1,047 | 1,004 | 1,156 | 1,084 |
| DOL (μm) | 34 | 36 | 37 | 37 | 35 | 37 |
| Crack resistance (gf) | Unmea- | Unmea- | Unmea- | Unmea- | Unmea- | 800 |
| | sured | sured | sured | sured | sured | |

TABLE 9

| | | Example | | | | | |
|---|---|---|---|---|---|---|---|
| | | No. 48 | No. 49 | No. 50 | No. 51 | No. 52 | No. 53 |
| Glass | SiO₂ | 66.1 | 66.5 | 66.5 | 65.9 | 66.4 | 67.0 |
| composition | Al₂O₃ | 12.1 | 12.1 | 12.2 | 12.8 | 12.8 | 13.6 |
| (mol %) | MgO | 4.0 | 3.2 | 1.7 | 4.8 | 3.2 | 1.7 |
| | B₂O₃ | 2.3 | 2.7 | 3.8 | 0.9 | 1.9 | 1.9 |
| | Na₂O | 15.4 | 15.4 | 15.7 | 15.5 | 15.6 | 15.7 |
| | K₂O | 0.0 | 0.0 | 0.0 | 0.0 | 0.0 | 0.0 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 15.4 | 15.4 | 15.7 | 15.5 | 15.6 | 15.7 |
| MgO + CaO + SrO + BaO | 4.0 | 3.2 | 1.7 | 4.8 | 3.3 | 1.7 |
| Li₂O + Na₂O + K₂O + MgO + CaO + | 19.4 | 18.7 | 17.4 | 20.3 | 18.9 | 17.4 |
| SrO + BaO | | | | | | |
| B₂O₃/(B₂O₃ + Li₂O + Na₂O + | 0.11 | 0.13 | 0.18 | 0.04 | 0.09 | 0.10 |
| K₂O + MgO + CaO + SrO + BaO) | | | | | | |
| Density (g/cm³) | 2.43 | 2.43 | 2.42 | 2.44 | 2.43 | 2.42 |
| α (×10⁻⁷/° C.) | 82 | 83 | 83 | 83 | 83 | 84 |
| Ps (° C.) | 576 | 572 | 561 | 607 | 590 | 600 |
| Ta (° C.) | 626 | 622 | 607 | 660 | 642 | 655 |
| Ts (° C.) | 872 | 867 | 840 | 911 | 898 | 923 |
| 10⁴ dPa · s (° C.) | 1,261 | 1,268 | 1,266 | 1,304 | 1,299 | Unmea- |
| | | | | | | sured |
| 10³ dPa · s (° C.) | 1,465 | 1,475 | 1,485 | 1,497 | 1,503 | Unmea- |
| | | | | | | sured |
| 10^{2.5} dPa · s (° C.) | 1,601 | 1,603 | 1,621 | 1,625 | 1,628 | Unmea- |
| | | | | | | sured |
| TL (° C.) | 1,025 | 920 | 1,081 | 1,155 | 1,036 | 1,042 |
| log₁₀η_{TL} (dPa · s) | 5.8 | 6.9 | 5.2 | 5.0 | 6.0 | 6.3 |
| CS (MPa) | 1,038 | 1,000 | 915 | 1,177 | 1,074 | 1,093 |
| DOL (μm) | 38 | 39 | 41 | 41 | 44 | 49 |
| Crack resistance (gf) | 1,000 | Unmea- | Unmea- | Unmea- | Unmea- | Unmea- |
| | | sured | sured | sured | sured | sured |

TABLE 10

| | | Example | | | | |
|---|---|---|---|---|---|---|
| | | No. 54 | No. 55 | No. 56 | No. 57 | No. 58 |
| Glass | SiO₂ | 66.5 | 66.2 | 66.4 | 66.5 | 66.7 |
| composition | Al₂O₃ | 12.2 | 12.2 | 12.2 | 12.3 | 12.3 |
| (mol %) | MgO | 3.3 | 4.1 | 4.1 | 2.4 | 2.5 |
| | B₂O₃ | 2.5 | 2.4 | 2.5 | 2.5 | 2.5 |
| | Na₂O | 14.4 | 14.3 | 13.3 | 15.5 | 14.5 |
| | K₂O | 1.0 | 0.7 | 1.4 | 0.7 | 1.4 |
| | SnO₂ | 0.1 | 0.1 | 0.1 | 0.1 | 0.1 |

| | | | | | |
|---|---|---|---|---|---|
| Li₂O + Na₂O + K₂O | 15.5 | 15.1 | 14.8 | 16.2 | 15.9 |
| MgO + CaO + SrO + BaO | 3.3 | 4.1 | 4.1 | 2.4 | 2.5 |
| Li₂O + Na₂O + K₂O + MgO + Ca | 18.7 | 19.1 | 18.8 | 18.7 | 18.4 |
| O + SrO + BaO | | | | | |
| B₂O₃/(B₂O₃ + Li₂O + Na₂O + | 0.12 | 0.11 | 0.12 | 0.12 | 0.12 |
| K₂O + MgO + CaO + SrO + BaO) | | | | | |
| Density(g/cm³) | 2.43 | 2.43 | 2.43 | 2.44 | 2.43 |
| α (×10⁻⁷/° C) | 85 | 84 | 84 | 87 | 87 |
| Ps (° C) | 571 | 576 | 578 | 564 | 564 |
| Ta (° C) | 621 | 627 | 631 | 612 | 614 |
| Ts (° C) | 874 | 880 | 889 | 855 | 865 |
| 10⁴ dPa · s (° C) | 1,284 | 1,281 | 1,294 | 1,265 | 1,283 |
| 10³ dPa · s (° C) | 1,495 | 1,486 | 1,502 | 1,476 | 1,499 |
| 10^{2.5} dPa · s (° C) | 1,623 | 1,616 | 1,630 | 1,612 | 1,635 |
| TL (° C) | 940 | 1,045 | 1,081 | 999 | 1,006 |
| log₁₀η_{TL} (dPa-s) | 6.7 | 5.7 | 5.5 | 5.9 | 6.0 |
| CS (MPa) | 995 | 1,029 | 1,008 | Unmeasured | 930 |
| DOL (μm) | 42 | 42 | 40 | Unmeasured | 49 |
| Crack resistance (gf) | 1,500 | Unmeasured | Unmeasured | Unmeasured | Unmeasured |

TABLE 11

| | | Example | | | | | |
|---|---|---|---|---|---|---|---|
| | | No. 59 | No. 60 | No. 61 | No. 62 | No. 63 | No. 64 |
| Glass | SiO₂ | 67.9 | 67.1 | 66.6 | 66.3 | 68.8 | 67.7 |
| composition | Al₂O₃ | 11.5 | 12.2 | 11.6 | 12.2 | 10.0 | 10.0 |
| (mol %) | MgO | 4.1 | 4.1 | 4.1 | 4.1 | 4.8 | 4.8 |
| | B₂O₃ | 4.7 | 4.9 | 5.9 | 5.7 | 2.8 | 3.6 |
| | Na₂O | 9.7 | 9.6 | 9.7 | 9.6 | 12.7 | 13.1 |
| | K₂O | 2.0 | 2.0 | 2.0 | 2.0 | 0.8 | 0.7 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 11.7 | 11.6 | 11.7 | 11.6 | 13.5 | 13.8 |
| MgO + CaO + SrO + BaO | 4.1 | 4.1 | 4.1 | 4.1 | 4.8 | 4.8 |
| Li₂O + Na₂O + K₂O + MgO + CaO + | 15.8 | 15.7 | 15.9 | 15.7 | 18.2 | 18.6 |
| SrO + BaO | | | | | | |
| B₂O₃/(B₂O₃ + Li₂O + Na₂O + | 0.23 | 0.24 | 0.27 | 0.27 | 0.13 | 0.16 |
| K₂O + MgO + CaO + SrO + BaO) | | | | | | |
| Density (g/cm³) | 2.39 | 2.39 | 2.38 | 2.39 | 2.41 | 2.42 |
| α (×10⁻⁷/° C.) | 73 | 71 | 72 | 72 | 77 | 78 |
| Ps (° C.) | 577 | 582 | 567 | 572 | 569 | 558 |
| Ta (° C.) | 631 | 637 | 619 | 625 | 618 | 604 |
| Ts (° C.) | 902 | 907 | 882 | 888 | 866 | 839 |
| 10⁴ dPa · s (° C.) | 1,327 | 1,326 | 1,317 | 1,317 | 1,274 | 1,244 |
| 10³ dPa · s (° C.) | 1,531 | 1,526 | 1,521 | 1,519 | 1,487 | 1,454 |
| 10^{2.5} dPa · s (° C.) | 1,658 | 1,649 | 1,642 | 1,640 | 1,617 | 1,584 |
| TL (° C.) | >1,160 | >1,160 | >1,160 | >1,160 | 1,071 | 1,038 |
| log₁₀η_{TL} (dPa · s) | <5.1 | <5.1 | <5.0 | <5.0 | 5.4 | 5.4 |
| CS (MPa) | 540 | 550 | 531 | 535 | 630 | 625 |
| DOL (μm) | 39 | 37 | 36 | 35 | 27 | 25 |
| Crack resistance (gf) | Unmea- | Unmea- | Unmea- | Unmea- | >1,000 | Unmea- |
| | sured | sured | sured | sured | | sured |

TABLE 12

| | | Example | | | | | |
|---|---|---|---|---|---|---|---|
| | | No. 65 | No. 66 | No. 67 | No. 68 | No. 69 | No. 70 |
| Glass | SiO₂ | 67.6 | 67.2 | 68.1 | 70.0 | 68.9 | 68.5 |
| composition | Al₂O₃ | 10.1 | 10.1 | 10.1 | 9.4 | 9.4 | 9.4 |
| (mol %) | MgO | 4.9 | 4.9 | 4.1 | 4.8 | 4.8 | 4.8 |
| | B₂O₃ | 3.3 | 3.4 | 3.6 | 2.6 | 3.6 | 3.5 |
| | Na₂O | 13.0 | 13.0 | 12.7 | 12.4 | 12.5 | 13.0 |
| | K₂O | 1.0 | 1.3 | 1.3 | 0.7 | 0.7 | 0.7 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 14.0 | 14.3 | 14.0 | 13.1 | 13.2 | 13.7 |
| MgO + CaO + SrO + BaO | 4.9 | 4.9 | 4.2 | 4.8 | 4.8 | 4.8 |
| Li₂O + Na₂O + K₂O + MgO + CaO + | 18.9 | 19.2 | 18.2 | 17.9 | 18.0 | 18.5 |
| SrO + BaO | | | | | | |
| B₂O₃/(B₂O₃ + Li₂O + Na₂O + | 0.15 | 0.15 | 0.17 | 0.13 | 0.17 | 0.16 |
| K₂O + MgO + CaO + SrO + BaO) | | | | | | |
| Density (g/cm³) | 2.42 | 2.42 | 2.42 | 2.41 | 2.41 | 2.42 |
| α (×10⁻⁷/° C.) | 80 | 81 | 80 | 75 | 76 | 78 |
| Ps (° C.) | 560 | 556 | 556 | 569 | 560 | 558 |
| Ta (° C.) | 606 | 602 | 603 | 618 | 607 | 604 |
| Ts (° C.) | 840 | 833 | 839 | 865 | 845 | 838 |
| 10⁴ dPa · s (° C.) | 1,263 | 1,250 | 1,271 | 1,294 | 1,245 | 1,263 |
| 10³ dPa · s (° C.) | 1,475 | 1,460 | 1,488 | 1,508 | 1,460 | 1,477 |
| 10^{2.5} dPa · s (° C.) | 1,604 | 1,590 | 1,623 | 1,640 | 1,594 | 1,607 |
| TL (° C.) | 1,031 | 999 | 952 | 1,060 | 1,038 | 983 |
| log₁₀η_{TL} (dPa · s) | 5.5 | 5.7 | 6.3 | 5.6 | 5.4 | 6.0 |
| CS (MPa) | 622 | 609 | 612 | 623 | 626 | 615 |
| DOL (μm) | 27 | 28 | 28 | 27 | 25 | 26 |
| Crack resistance (gf) | Unmea- | >1,000 | Unmea- | >1,000 | Unmea- | >1,000 |
| | sured | | sured | | sured | |

TABLE 13

| | | Example | | | | | |
|---|---|---|---|---|---|---|---|
| | | No. 71 | No. 72 | No. 73 | No. 74 | No. 75 | No. 76 |
| Glass | SiO₂ | 68.1 | 67.8 | 69.4 | 69.3 | 68.9 | 70.6 |
| composition | Al₂O₃ | 9.5 | 9.5 | 9.5 | 9.4 | 9.4 | 8.7 |
| (mol %) | MgO | 4.8 | 4.8 | 4.0 | 4.0 | 4.0 | 4.8 |
| | B₂O₃ | 3.6 | 3.5 | 3.4 | 36 | 3.7 | 2.7 |
| | Li₂O | 0.0 | 0.02 | 0.02 | 0.0 | 0.0 | 0.0 |
| | Na₂O | 12.9 | 13.0 | 12.9 | 12.5 | 12.6 | 12.4 |
| | K₂O | 1.0 | 1.3 | 0.7 | 1.1 | 1.3 | 0.7 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 13.9 | 14.32 | 13.62 | 13.6 | 13.9 | 13.1 |
| MgO + CaO + SrO + BaO | 4.8 | 4.8 | 4.0 | 4.0 | 4.0 | 4.8 |
| Li₂O + Na₂O + K₂O + MgO + CaO + | 18.7 | 19.12 | 17.62 | 17.6 | 17.9 | 17.9 |
| SrO + BaO | | | | | | |
| B₂O₃/(B₂O₃ + Li₂O + Na₂O + | 0.16 | 0.15 | 0.16 | 0.17 | 0.17 | 0.13 |
| K₂O + MgO + CaO + SrO + BaO) | | | | | | |
| Density (g/cm³) | 2.42 | 2.42 | 2.41 | 2.41 | 2.42 | 2.41 |
| α (×10⁻⁷/° C.) | 79 | 81 | 78 | 79 | 79 | 76 |
| Ps (° C.) | 554 | 551 | 555 | 556 | 554 | 564 |
| Ta (° C.) | 599 | 596 | 601 | 602 | 600 | 612 |
| Ts (° C.) | 828 | 821 | 835 | 838 | 831 | 854 |
| 10⁴ dPa · s (° C.) | 1,230 | 1,236 | 1,261 | 1,249 | 1,255 | 1,276 |
| 10³ dPa · s (° C.) | 1,443 | 1,451 | 1,477 | 1,468 | 1,475 | 1,492 |
| 10^{2.5} dPa · s (° C.) | 1,579 | 1,581 | 1,614 | 1,607 | 1,612 | 1,629 |
| TL (° C.) | 966 | 915 | 934 | 930 | 912 | 1,016 |
| log₁₀η_{TL} (dPa · s) | 5.9 | 6.4 | 6.4 | 6.4 | 6.6 | 5.8 |
| CS (MPa) | 626 | 604 | 626 | 610 | 600 | 610 |
| DOL (μm) | 25 | 28 | 27 | 27 | 28 | 26 |
| Crack resistance (gf) | >1,000 | >1,000 | >1,000 | >1,000 | >1,000 | >1,000 |

TABLE 14

| | | Example | | | | | |
|---|---|---|---|---|---|---|---|
| | | No. 77 | No. 78 | No. 79 | No. 80 | No. 81 | No. 82 |
| Glass | SiO₂ | 69.1 | 69.2 | 68.7 | 70.1 | 70.1 | 69.6 |
| composition | Al₂O₃ | 8.7 | 8.8 | 8.8 | 8.7 | 8.8 | 8.7 |
| (mol %) | MgO | 4.8 | 4.8 | 4.8 | 4.0 | 4.0 | 4.0 |
| | B₂O₃ | 3.7 | 3.3 | 3.4 | 3.5 | 3.6 | 3.8 |
| | Li₂O | 0.02 | 0.0 | 0.0 | 0.0 | 0.0 | 0.0 |
| | Na₂O | 12.9 | 12.8 | 12.9 | 12.9 | 12.4 | 12.5 |
| | K₂O | 0.7 | 1.0 | 1.3 | 0.7 | 1.0 | 1.3 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 13.62 | 13.8 | 14.2 | 13.6 | 13.4 | 13.9 |
| MgO + CaO + SrO + BaO | 4.8 | 4.8 | 4.8 | 4.0 | 4.0 | 4.0 |
| Li₂O + Na₂O + K₂O + MgO + CaO + | 18.42 | 18.6 | 19.0 | 17.6 | 17.4 | 17.9 |
| SrO + BaO | | | | | | |
| B₂O₃/(B₂O₃ + Li₂O + Na₂O + | 0.17 | 0.15 | 0.15 | 0.17 | 0.17 | 0.17 |
| K₂O + MgO + CaO + SrO + BaO) | | | | | | |
| Density (g/cm³) | 2.42 | 2.42 | 2.42 | 2.41 | 2.41 | 2.42 |
| α (×10⁻⁷/° C.) | 78 | 79 | 81 | 77 | 77 | 79 |
| Ps (° C.) | 553 | 554 | 549 | 555 | 555 | 550 |
| Ta (° C.) | 598 | 599 | 593 | 600 | 600 | 594 |
| Ts (° C.) | 823 | 824 | 814 | 825 | 829 | 819 |
| 10⁴ dPa · s (° C.) | 1,229 | 1,245 | 1,231 | 1,240 | 1,241 | 1,235 |
| 10³ dPa · s (° C.) | 1,446 | 1,460 | 1,449 | 1,460 | 1,462 | 1,456 |
| 10^{2.5} dPa · s (° C.) | 1,582 | 1,592 | 1,585 | 1,595 | 1,601 | 1,595 |
| TL (° C.) | 911 | 946 | 930 | 961 | 917 | 904 |
| log₁₀η_{TL} (dPa · s) | 6.5 | 6.2 | 6.2 | 6.0 | 6.5 | 6.5 |
| CS (MPa) | 604 | 602 | 589 | 604 | 592 | 582 |
| DOL (μm) | 25 | 25 | 27 | 25 | 27 | 28 |
| Crack resistance (gf) | >1,000 | 1,000 | >1,000 | >1,000 | Unmea- | Unmea- |
| | | | | | sured | sured |

TABLE 15

| | | Example | | | | | |
|---|---|---|---|---|---|---|---|
| | | No. 83 | No. 84 | No. 85 | No. 86 | No. 87 | No. 88 |
| Glass | SiO₂ | 69.2 | 69.7 | 69.9 | 70.0 | 69.8 | 69.7 |
| composition | Al₂O₃ | 8.8 | 8.8 | 8.7 | 8.7 | 8.6 | 8.7 |
| (mol %) | MgO | 4.8 | 4.8 | 4.8 | 4.8 | 4.7 | 4.7 |
| | B₂O₃ | 2.6 | 1.2 | 2.3 | 1.6 | 1.4 | 0.9 |
| | Li₂O | 0.02 | 0.02 | 0.02 | 0.02 | 0.02 | 0.02 |
| | Na₂O | 13.9 | 14.7 | 13.7 | 14.4 | 14.9 | 15.5 |
| | K₂O | 0.7 | 0.7 | 0.4 | 0.4 | 0.4 | 0.4 |
| | SnO₂ | 0.1 | 0.1 | 0.1 | 0.1 | 0.1 | 0.1 |

| | | | | | | |
|---|---|---|---|---|---|---|
| Li₂O + Na₂O + K₂O | 14.6 | 15.4 | 14.2 | 14.8 | 15.4 | 15.9 |
| MgO + CaO + SrO + BaO | 4.8 | 4.8 | 4.8 | 4.8 | 4.8 | 4.8 |
| Li₂O + Na₂O + K₂O + MgO + CaO + | 19.4 | 20.2 | 19.0 | 19.6 | 20.1 | 20.7 |
| SrO + BaO | | | | | | |
| B₂O₃/(B₂O₃ + Li₂O + Na₂O + | 0.12 | 0.06 | 0.11 | 0.08 | 0.06 | 0.04 |
| K₂O + MgO + CaO + SrO + BaO) | | | | | | |
| Density (g/cm³) | 2.43 | 2.43 | 2.42 | 2.43 | 2.43 | 2.43 |
| α (×10⁻⁷/° C.) | 81 | 85 | 79 | 82 | 84 | 86 |
| Ps (° C.) | 554 | 552 | 558 | 560 | 557 | 554 |
| Ta (° C.) | 599 | 597 | 604 | 605 | 602 | 599 |
| Ts (° C.) | 822.5 | 819 | 831 | 833.5 | 828 | 824.5 |
| 10⁴ dPa · s (° C.) | 1,222 | 1,218 | 1,243 | 1,241 | 1,231 | 1,216 |
| 10³ dPa · s (° C.) | 1,435 | 1,430 | 1,459 | 1,454 | 1,444 | 1,427 |
| 10^{2.5} dPa · s (° C.) | 1,571 | 1,565 | 1,595 | 1,589 | 1,580 | 1,560 |
| TL (° C.) | 908 | 916 | 944 | 945 | Unmea- | Unmea- |
| | | | | | sured | sured |
| log₁₀η_{TL} (dPa · s) | 6.5 | 6.4 | 6.2 | 6.2 | Unmea- | Unmea- |
| | | | | | sured | sured |
| CS (MPa) | 623 | 645 | 658 | 623 | 618 | 594 |
| DOL (μm) | 27 | 30 | 26 | 29 | 29 | 32 |
| Crack resistance (gf) | Unmea- | Unmea- | Unmea- | Unmea- | Unmea- | Unmea- |
| | sured | sured | sured | sured | sured | sured |

TABLE 16

| | | Example | | | |
|---|---|---|---|---|---|
| | | No. 89 | No. 90 | No. 91 | No. 92 |
| Glass | SiO₂ | 70.6 | 70.9 | 70.4 | 69.9 |
| composition | Al₂O₃ | 8.8 | 8.8 | 8.7 | 8.7 |
| (mol %) | MgO | 4.0 | 4.0 | 4.0 | 3.9 |
| | B₂O₃ | 2.8 | 2.1 | 1.6 | 0.9 |
| | Li₂O | 0.02 | 0.02 | 0.02 | 0.02 |
| | Na₂O | 13.3 | 13.7 | 14.8 | 16.0 |
| | K₂O | 0.4 | 0.4 | 0.4 | 0.4 |
| | SnO₂ | 0.1 | 0.1 | 0.1 | 0.1 |

| | | | | |
|---|---|---|---|---|
| Li₂O + Na₂O + K₂O | 13.7 | 14.1 | 15.2 | 16.4 |
| MgO + CaO + SrO + BaO | 4.0 | 4.0 | 4.0 | 4.0 |
| Li₂O + Na₂O + K₂O + MgO + Ca | 17.7 | 18.1 | 19.2 | 20.4 |
| O + SrO + BaO | | | | |
| B₂O₃/(B₂O₃ + Li₂O + Na₂O + | 0.14 | 0.10 | 0.07 | 0.04 |
| K₂O + MgO + CaO + SrO + BaO) | | | | |
| Density (g/cm³) | 2.41 | 2.42 | 2.43 | 2.44 |
| α (×10⁻⁷/° C) | 77 | 79 | 83 | 87 |
| Ps (° C) | 559 | 560 | 554 | 546 |
| Ta (° C) | 604 | 605 | 599 | 590 |
| Ts (° C) | 830.5 | 834.5 | 823.5 | 821 |
| 10⁴ dPa · s (° C) | 1,258 | 1,257 | 1,231 | 1,213 |
| 10³ dPa · s (° C) | 1,478 | 1,477 | 1,448 | 1,427 |
| 10^{2.5} dPa · s (° C) | 1,616 | 1,615 | 1,584 | 1,563 |
| TL (° C) | 900 | 915 | Unmeasured | Unmeasured |
| log₁₀η_{TL} (dPa · s) | 6.7 | 6.6 | Unmeasured | Unmeasured |
| CS (MPa) | 616 | 624 | 599 | 549 |
| DOL (μm) | 29 | 27 | 29 | 32 |
| Crack resistance (gf) | Unmeasured | Unmeasured | Unmeasured | Unmeasured |

Each of the samples in the tables was produced as described below. First, glass raw materials were blended so as to have glass compositions shown in the tables, and melted at 1,600° C. using a platinum pot. The time period of the melting for each of the samples Nos. 1 to 58 is 8 hours, and the time period of the melting for each of the samples Nos. 59 to 92 is 21 hours. Thereafter, the resultant molten glass was cast on a carbon plate and formed into a sheet shape. The resultant glass sheet was evaluated for its various properties.

The density is a value obtained through measurement by a known Archimedes method.

The thermal expansion coefficient α is a value obtained through measurement of an average thermal expansion coefficient in a temperature range of from 30 to 380° C. using a dilatometer.

The crack resistance refers to a load at a crack generation rate of 50%. The crack generation rate was measured as described below. First, in a constant temperature and humidity chamber kept at a humidity of 30% and a temperature of 25° C., a Vickers indenter set to a predetermined load is driven into a glass surface (optically polished surface) for 15 seconds, and 15 seconds after that, the number of cracks generated from the four corners of the indentation is counted (4 per indentation at maximum). The indenter was driven in this manner 20 times, the total number of generated cracks was determined, and then the crack generation rate was determined by the following expression: total number of generated cracks/80×100(%).

The strain point Ps and the annealing point Ta are values obtained through measurement based on a method of ASTM C336.

The softening point Ts is a value obtained through measurement based on a method of ASTM C338.

The temperatures at the viscosities at high temperature of 10^{4.0} dPa·s, 10^{3.0} dPa·s, and 10^{2.5} dPa·s are values obtained through measurement by a platinum sphere pull up method.

The liquidus temperature TL is a value obtained through measurement of a temperature at which crystals of glass are deposited after glass powder that passes through a standard 30-mesh sieve (sieve opening: 500 μm) and remains on a 50-mesh sieve (sieve opening: 300 μm) is placed in a platinum boat and then kept for 24 hours in a gradient heating furnace.

The liquidus viscosity log η_{TL} is a value obtained through measurement of a viscosity of glass at the liquidus temperature by a platinum sphere pull up method.

As evident from Tables 1 to 16, each of the samples had a density of 2.45 g/cm³ or less, a thermal expansion coefficient of from 69×10⁻⁷ to 92×10⁻⁷/° C., and a crack resistance of from 500 to 1,500 gf and was found to be suitable as a material for a tempered glass, i.e., a glass to be tempered. Further, each of the samples has a liquidus viscosity of 10^{4.0} dPa·s or more, thus being able to be formed into a sheet shape by the overflow down-draw method, and moreover, has a temperature at 10^{2.5} dPa·s of 1,658° C. or less. This is considered to allow a large number of glass sheets to be produced at low cost with high productivity.

It should be noted that the glass compositions of a surface layer of glass before and after tempering treatment are different from each other microscopically, but the glass composition of the whole glass is not substantially changed before and after the tempering treatment.

Subsequently, both surfaces of each of the samples were subjected to optical polishing. After that, ion exchange treatment was performed through immersion in a KNO₃ molten salt (KNO₃ molten salt having no use history) at 440° C. for 6 hours for the samples Nos. 1 to 58, and a KNO₃ molten salt (KNO₃ molten salt having a Na ion concentration of 20,000 ppm) at 430° C. for 4 hours for the samples Nos. 59 to 92. After completion of the ion exchange treatment, the surface of each of the samples was washed. Then, the stress compression value (CS) and thickness (DOL) of a compression stress layer in the surface were calculated from the number of interference fringes and each interval between the interference fringes, the interference fringes being observed with a surface stress meter (FSM-6000 manufactured by Toshiba Corporation). In the calculation, the refractive index and optical elastic constant of each of the samples Nos. 1 to 58 were set to 1.51 and 30 [ (nm/cm)/MPa], respectively, and the refractive index and optical elastic constant of each of the samples Nos. 59 to 92 were set to 1.50 and 31 [(nm/cm)/MPa], respectively.

As apparent from Tables 1 to 16, when each sample was subjected to ion exchange treatment in a KNO₃ molten salt, the compression stress layer in its surface had a compression stress value of 531 MPa or more and a thickness of 25 μm or more. In addition, each sample has high crack resistance, and hence is considered to hardly have a flaw created on its surface and be suitable for cutting after tempering, in particular, scribe cutting after tempering.

### Example 2

Glass raw materials were blended so as to have the glass composition of each of Samples Nos. 25 to 29 shown in Table 5, melted, and fined. After that, the resultant molten glass was formed into a sheet shape by an overflow down-draw method to obtain a glass sheet having a sheet thickness of 0.7 mm. The presence or absence of a surface flaw was visually observed by irradiating the obtained glass sheet with light of 4,000 lux. As a result, no surface flaw having a length of 10 mm or more was found on the obtained glass sheet.

### INDUSTRIAL APPLICABILITY

The tempered glass and tempered glass sheet of the present invention are suitable for a cover glass of a cellular phone, a digital camera, a PDA, or the like, or a glass substrate for a touch panel display or the like. Further, the tempered glass and tempered glass sheet of the present invention can be expected to find use in applications requiring high mechanical strength, for example, a window glass, a substrate for a magnetic disk, a substrate for a flat panel display, a cover glass for a solar battery, a cover glass for a solid image pick-up element, and tableware, in addition to the above-mentioned applications.

1. A tempered glass having a compression stress layer in a surface thereof, comprising, as a glass composition, in terms of mol %, 50 to 80% of SiO₂, 5 to 30% of Al₂O₃, 0 to 2% of Li₂O, and 5 to 25% of Na₂O, and being substantially free of As₂O₃, Sb₂O₃, PbO, and F.

2-4. (canceled)

5. The tempered glass according to claim 1, comprising as a glass composition, in terms of mol %, 50 to 77% of SiO₂, 6.5 to 15% of Al₂O₃, 0.01 to 15% of B₂O₃, 0 to 1% of Li₂O, 9 to 15.5% of Na₂O, 9 to 15.5% of Li₂O+Na₂O+K₂O, 0 to 2% of CaO, 0 to 6.5% of MgO+CaO+SrO+BaO, 15.5 to 22% of Li₂O+Na₂O+K₂O+MgO+CaO+SrO+BaO, and 0 to 0.1% of P₂O₅, and being substantially free of As₂O₃, Sb₂O₃, PbO, and F.

6. The tempered glass according to claim 1, comprising as a glass composition, in terms of mol %, 50 to 77% of SiO₂, 6.5 to 15% of Al₂O₃, 0 to 1% of Li₂O, 9 to 15.5% of Na₂O, 9 to 15.5% of Li₂O+Na₂O+K₂O, 0 to 2% of CaO, 0 to 6.5% of MgO+CaO+SrO+BaO, 15.5 to 22% of Li₂O+Na₂O+K₂O+MgO+CaO+SrO+BaO, and 0 to 0.1% of P₂O₅, having a molar ratio B₂O₃/(B₂O₃+Li₂O+Na₂O+K₂O+MgO+CaO+SrO+BaO) of from 0.06 to 0.35, and being substantially free of As₂O₃, Sb₂O₃, PbO, and F.

7. The tempered glass according to claim 1, wherein the tempered glass has a density of 2.45 g/cm³ or less.

8. The tempered glass according to claim 1, wherein the tempered glass has a crack resistance before tempering treatment of 300 gf or more.

9. The tempered glass according to claim 1, wherein a compression stress value of the compression stress layer is 300 MPa or more, and a thickness of the compression stress layer is 10 μm or more.

10. (canceled)

11. The tempered glass according to claim 1, wherein the tempered glass has a liquidus viscosity of 10^{4.0} dPa·s or more.

12. The tempered glass according to claim 1, wherein the tempered glass has a temperature at 10^{4.0} dPa·s of 1,300° C. or less.

13. The tempered glass according to claim 1, wherein the tempered glass has a thermal expansion coefficient in a temperature range of from 30 to 380° C. of 95×10⁻⁷/° C. or less.

14. A tempered glass sheet, comprising the tempered glass according to claim 1.

15. The tempered glass sheet according to claim 14, wherein the tempered glass sheet is subjected to scribe cutting after tempering.

16. The tempered glass sheet according to claim 14, wherein the tempered glass sheet has a length dimension of 500 mm or more, a width dimension of 300 mm or more, and a thickness of from 0.5 to 2.0 mm, and has a compression stress value of the compression stress layer of 300 MPa or more and a thickness of the compression stress layer of 10 μm or more.

17. The tempered glass sheet according to claim 14, wherein the tempered glass sheet is formed by an overflow down-draw method.

18. The tempered glass sheet according to claim 14, wherein the tempered glass sheet is free of surface flaws, or when the tempered glass sheet has surface flaws, a number of surface flaws each having a length of 10 μm or more is 120/cm² or less.

19. The tempered glass sheet according to claim 14, wherein the tempered glass sheet is used for a touch panel display.

20. The tempered glass sheet according to claim 14, wherein the tempered glass sheet is used for a cover glass for a cellular phone.

21-22. (canceled)

23. A tempered glass sheet having a length dimension of 500 mm or more, a width dimension of 300 mm or more, and a thickness of from 0.3 to 2.0 mm,
the tempered glass sheet being free of surface flaws, or when the tempered glass sheet has surface flaws, a number of surface flaws each having a length of 10 μm or more being 120/cm² or less,
the tempered glass sheet comprising as a glass composition, in terms of mol %, 50 to 77% of SiO₂, 6.5 to 15% of Al₂O₃, 0.01 to 10% of B₂O₃, 0 to 1% of Li₂O, 9.0 to 15.5% of Na₂O, 9 to 15.5% of Li₂O+Na₂O+K₂O, 0 to 2% of CaO, 0 to 6.5% of MgO+CaO+SrO+BaO, 15.5 to 22% of Li₂O+Na₂O+K₂O+MgO+CaO+SrO+BaO, and 0 to 0.1% of P₂O₅, having a molar ratio B₂O₃/(B₂O₃+Li₂O+Na₂O+K₂O+MgO+CaO+SrO+BaO) of 0.06 to 0.35, and being substantially free of As₂O₃, Sb₂O₃, PbO, and F, the tempered glass sheet having a density of 2.45 g/cm³ or less, a compression stress value of a compression stress layer of 300 MPa or more, a thickness of the compression stress layer of 10 μm or more, a liquidus temperature of 1,200° C. or less, a thermal expansion coefficient in a temperature range of from 30 to 380° C. of 95×10⁷₁° C. or less, and a crack resistance before tempering treatment of 300 gf or more.

24. A glass to be tempered, comprising as a glass composition, in terms of mol %, 50 to 80% of SiO₂, 5 to 30% of Al₂O₃, 0 to 2% of Li₂O, and 5 to 25% of Na₂O, and being substantially free of As₂O₃, Sb₂O₃, PbO, and F.

25. The glass to be tempered according to claim 24, wherein the glass to be tempered has a crack resistance of 300 gf or more.
